(19) United States
(12) Patent Application Publication
(10) Pub. No.: US 2015/0327745 A1
(43) Pub. Date: Nov. 19, 2015

(54) CLEANING SHEET AND MANUFACTURING METHOD THEREFOR

(71) Applicant: KAO CORPORATION, Tokyo (JP)

(72) Inventors: Kouji MACHII, Moka-shi (JP); Yukihiro KANEKO, Chicago, IL (US); Chiharu OMORI, Utsunomiya-shi (JP)

(73) Assignee: KAO CORPORATION, Tokyo (JP)

(21) Appl. No.: 14/388,143

(22) PCT Filed: Mar. 26, 2013
(86) PCT No.: PCT/JP2013/058763

§ 371 Date: Sep. 25, 2014

(30) Foreign Application Priority Data
May 28, 2012 (JP) 2012-121126
Mar. 6, 2013 (JP) 2013-044247

(51) Int. Cl. A47L 13/16; D04H 1/44; D04H 3/11; B08B 1/00; D04H 1/495

(52) U.S. Cl. CPC A47L 13/16; B08B 1/006; D04H 1/495; D04H 3/11; D04H 1/44; D10B 2401/022

(57) ABSTRACT

A cleaning sheet (1) includes a hydrophilic fiber aggregate (11) and a hydrophobic fiber aggregate (12) disposed on both sides of the hydrophilic fiber aggregate (11). The hydrophobic fiber aggregate (12) has its constituent fibers (14) entangled with one another, entering the hydrophilic fiber aggregate (11), and entangled with fibers (13) of the hydrophilic fiber aggregate (11). The cleaning sheet (1) is three-dimensionally textured with a plurality of protrusions (2) and a plurality of depressions (3) on both sides thereof. The protrusions (2) on one side correspond to the depressions (3) on the other side, and the depressions (3) on one side correspond to the protrusions (2) on the other side. The cleaning sheet (1) has linear bonds (15) where the hydrophilic fiber aggregate (11) and the hydrophobic fiber aggregate (12) are bonded to each other.

### TECHNICAL FIELD

The present invention relates to a three-dimensionally textured cleaning sheet and a method for producing the same.

### BACKGROUND ART

Disposable cleaning sheets are roughly divided into those for dry mopping and those for damp mopping. Disposable cleaning sheets for damp mopping include what we call wet cleaning sheets previously impregnated with a cleansing fluid or water and cleaning sheets that wipe up intentionally sprinkled cleansing fluid or water. A disposable cleaning sheet for damp mopping should be a fibrous or sheet structure having water retentivity and water absorptivity. It is desirable even for a disposable cleaning sheet for dry mopping to have water retentivity so that it may work as well even when the surface being cleaned, e.g., a floor has sprinkled water.

Patent Literature 1 below discloses a three-layered cleaning sheet composed of an absorbent sheet and a liquid-permeable surface sheet containing pulp fiber and laminated on both sides of the absorbent sheet. Patent Literatures 2 and 3 below disclose a wiping sheet formed by bonding a stack of three sheets along bonding lines, the stack being composed of an intermediate sheet of nonwoven fabric and a sheet of hydroentangled nonwoven fabric disposed on both sides of the intermediate sheet.

The cleaning sheet of Patent Literature 1 allows a user to do damp mopping with a light force because it is produced by simultaneously uniting and texturing a three-layer stack (surface sheet/absorbent sheet/surface sheet) by heat embossing using a lattice patterned heat roller. The wiping sheets described in Patent Literatures 2 and 3 are capable of absorbing some water, if any, during dry mopping because the hydroentangled nonwoven fabric disposed on both sides of the intermediate sheet contains water retentive fibers, such as rayon and cellulosic fiber. Because the cleaning or wiping sheet according to any of Patent Literatures 1 to 3 is formed by bonding a multi-layer stack along bonding lines, it is prevented from elongating during a cleaning operation and thereby prevented from causing inconveniences, such as coming off a sweeper.

### CITATION LIST

### Patent Literature

Patent Literature 1: JP 10-286206A
Patent Literature 2: U.S. Pat. No. 6,013,349A
Patent Literature 3: EP 0959164A1

### SUMMARY OF INVENTION

Since the cleaning or wiping sheet of any of Patent Literatures 1 to 3 is formed by merely uniting a three-layer stack along bonding lines, it has difficulty in transporting wiped up water smoothly from the surface sheet into the inner (intermediate) sheet, sometimes retransmitting absorbed water back to the floor.

The invention provides a cleaning sheet that is prevented from elongating during a cleaning operation and thereby free from such inconveniences, like coming off a sweeper, is capable of smoothly transferring water wiped up from a floor to the inner hydrophilic fiber aggregate, and allows little absorbed water to go back onto the floor.

The invention relates to a cleaning sheet including a hydrophilic fiber aggregate composed mainly of hydrophilic fibers, and a hydrophobic fiber aggregate composed mainly of hydrophobic fibers and disposed on both sides of the hydrophilic fiber aggregate. The hydrophobic fiber aggregate has its constituent fibers entangled with one another, entering the hydrophilic fiber aggregate, and entangled with fibers constituting the hydrophilic fiber aggregate in a way that the hydrophilic fiber aggregate and the hydrophilic fiber aggregate are united together. The cleaning sheet is three-dimensionally textured with a plurality of protrusions and a plurality of depressions on both sides thereof in a pattern such that protrusions on one side correspond to depressions on the other side and that depressions on one side correspond to protrusions on the other side. The cleaning sheet has a linear bond where the hydrophilic fiber aggregate and the hydrophobic fiber aggregate are bonded to each other.

### BRIEF DESCRIPTION OF DRAWINGS

FIG. 1 is a perspective view of an embodiment of the cleaning sheet according to the invention.

FIG. 2 is a developed perspective view of the cleaning sheet shown in FIG. 1.

FIG. 3 is a cross-sectional view taken along line I-I in FIG. 1.

FIG. 4 is an enlarged cross-sectional view of an essential part of the cleaning sheet shown in FIG. 1.

FIG. 5 schematically illustrates a method for counting the number, and measuring the height, of raised constituent fibers.

FIG. 6 illustrates measurement of the height of raised constituent fibers using a digital microscope in a vertical mode.

FIG. 7 is a schematic illustration of an apparatus suited to produce the cleaning sheet of FIG. 1.

FIG. 8 is a schematic perspective view of a raising part of the processing apparatus shown in FIG. 7.

FIG. 9 is schematic cross-sectional view of a texturing part of the processing apparatus shown in FIG. 7.

FIG. 10 is an enlarged cross-section view of an essential part of the texturing part shown in FIG. 9.

FIG. 11 is a schematic perspective view of a bonding part shown in FIG. 7.

FIG. 12 illustrates a cleaning implement used with the cleaning sheet of the invention.

### DESCRIPTION OF EMBODIMENTS

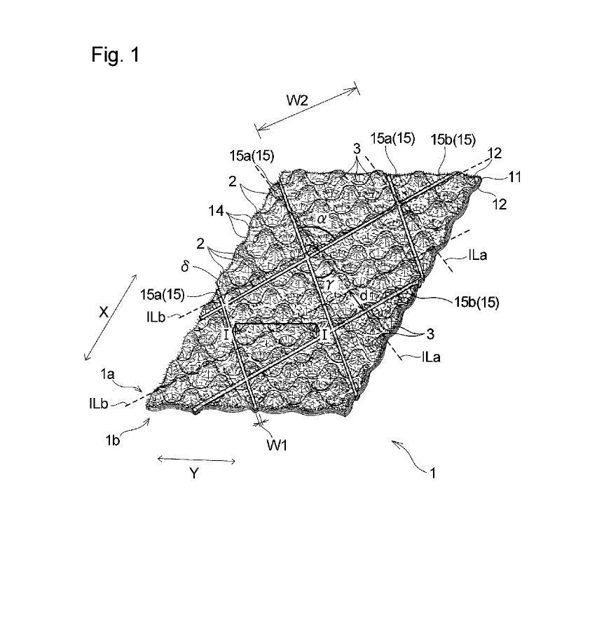

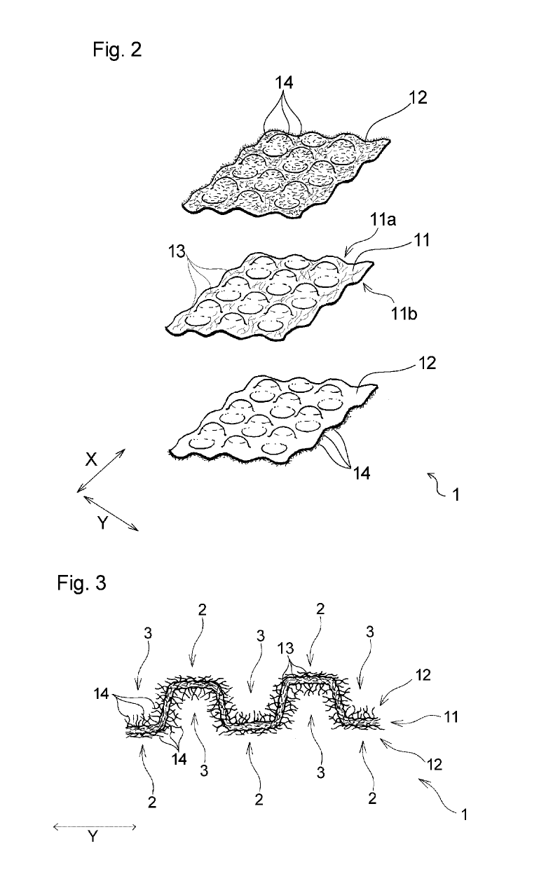

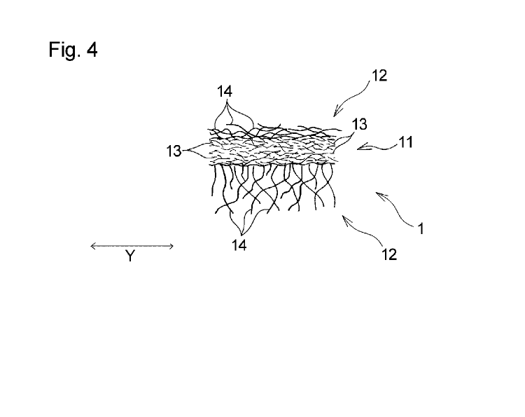

The cleaning sheet of the invention will be described based on its preferred embodiments with reference to the accompanying drawings. FIG. 1 shows an embodiment of the cleaning sheet of the invention. FIG. 2 represents a developed perspective view of the cleaning sheet of FIG. 1. FIGS. 3 and 4 are cross-sectional views of the cleaning sheet of FIG. 1. A cleaning sheet 1 of the present embodiment (hereinafter also simply referred to as “cleaning sheet 1”) includes a hydrophilic fiber aggregate 11 composed mainly of hydrophilic fibers, and a hydrophobic fiber aggregate 12 composed mainly of hydrophobic fibers and disposed on both sides 11a and 11b of the hydrophilic fiber aggregate 11. The hydrophobic fiber aggregate 12 has its constituent fibers 14 entangled with one another, entering the hydrophilic fiber aggregate 11, and entangled with fibers 13 constituting the hydrophilic fiber aggregate 11 in a way that the hydrophilic fiber aggregate 11 and the hydrophilic fiber aggregate 12 are united together to form the cleaning sheet 1. The thus formed cleaning sheet 1 has the hydrophilic fiber aggregate 11 of nonwoven fabric form located in the inside in the thickness direction thereof and the hydrophobic fiber aggregate 12 of fiber layer form located on each of a first side 1a thereof and a second side 1b opposite to the first side 1a. As shown in FIG. 4, the hydrophobic fiber aggregate 12 has its constituent fibers 14 entangled with one another and also has its constituent fibers 14 entering the inside of the hydrophilic fiber aggregate 11 and entangled with the fibers 13 making up the hydrophilic fiber aggregate 11. Thus, the hydrophilic fiber aggregate 11 and the hydrophobic fiber aggregates 12 are united into consolidated nonwoven fabric. The cleaning sheet 1 is what we call a dry cleaning sheet that is not intentionally impregnated with a liquid, such as a cleansing liquid. The developed perspective view of FIG. 2 is intended to illustrate the structure composed of the hydrophilic fiber aggregate 11 and the hydrophobic fiber aggregates 12 disposed on the sides 11a and 11b of the hydrophilic fiber aggregate 11 but not to show the three fiber aggregates delaminated from each other.

In what follows, taking note of the principal orientation direction of the fibers 14 making up the hydrophobic fiber aggregate 12, the MD, in which fibers are generally aligned, is defined to be direction X, and the CD perpendicular to the MD is defined to be direction Y. Understandably, the MD is the moving direction of the cleaning sheet being manufactured. As used herein, the term “fiber aggregate” refers to not only a non-consolidated fiber web before being processed into nonwoven fabric but also a consolidated fiber web of nonwoven fabric form. Each of directions X and Y is in parallel with one side of the cleaning sheet 1.

As shown in FIG. 1, the cleaning sheet 1 has a plurality of protrusions 2 and a plurality of depressions 3 on both sides thereof, i.e., the first side 1a and the second side 1b. The protrusions 2 formed on the first side 1a correspond to the depressions 3 formed on the second side 1b, and the protrusions 2 formed on the second side 1b correspond to the depressions formed on the first side 1a. The plurality of protrusions 2 are formed so as to protrude in a direction from one of the hydrophobic fiber aggregates 12 toward the other hydrophobic fiber aggregate 12, and the plurality of depressions 3 are formed so as to depress in the direction from the other hydrophobic fiber aggregate 12 toward one of the hydrophobic fiber aggregates 12. As a result, the cleaning sheet 1 has its either side textured three-dimensionally. In detail, each protrusion 2 on the first side 1a does not have a flat base on the second side 1b but is convex from the second side 1b toward the first side 1a, and each protrusion 2 on the second side 1b does not have a flat base on the first side 1a but is convex from the first side 1a toward the second side 1b. Likewise, each depression 3 on the first side 1a does not have its opposite side (second side 1b) flat but is concave from the first side 1a toward the second side 1b, and each depression 3 on the second side 1b does not have its opposite side (first side 1b) flat but is concave from the second side 1b toward the first side 1a.

As shown in FIG. 1, in the cleaning sheet 1, the protrusions 2 are arranged at a regular spacing so as to make lines in each of directions X and Y, and are arranged in a staggered pattern. Every depression 3 is surrounded by four protrusions 2, and the depressions 3 are also arranged in a staggered pattern. By this arrangement, the entire area of the cleaning sheet 1 is textured three-dimensionally. In more detail, the protrusions 2 are in an arrangement such that an imaginary line IL connecting the tops of two protrusions 2 adjacent to each other at the shortest distance d (see FIG. 1) intersects both directions X and Y. As depicted in FIG. 1, a plurality of protrusions 2 are arranged at a regular spacing in a first direction extending from a first imaginary line ILa. A plurality of protrusions are also arranged at a spacing substantially equal to the distance d in a second direction substantially perpendicular to the first direction, i.e., a direction extending from a second imaginary line ILb. There is a depressions 3 in every region surrounded by the thus arranged four protrusions 2.

As shown in FIG. 1, each protrusion 2 of the cleaning sheet 1 has a generally hemispherical shape, and each depression 3 has a same shape as the protrusion 2. Every protrusion 2 of the cleaning sheet 1 has a flat top. As previously discussed, since the protrusions 2 of the cleaning sheet 1 are a result of convexing from one of the first and second side 1a and 1b toward the other side, a protrusion 2 on the first side 1a corresponds to a depression 3 on the second side 1b, and, similarly, a depression 3 on the first side 1a corresponds to a protrusion 2 on the second side 1b. That is, the shape of the individual protrusions 2 is an inversion of the individual depressions 3. The thus textured cleaning sheet 1 exhibits the same properties on its sides 1a and 1b.

It is preferred for the cleaning sheet 1 to have at least 50, more preferably 100 or more protrusions 2, and 850 or less, more preferably 600 or less protrusions 2, per 10 cm square at any position of the first side 1a. With the density of the protrusions 2 being in that range, the protrusions 2 and the depressions 3 are arranged uniformly, so that the cleaning sheet 1 will exhibit better efficiency in collecting and trapping hairs and fluffy dust and excellent capabilities of capturing particulate dust.

In view of dust trapping capabilities and texture retention of the cleaning sheet 1, it is preferred for each protrusion 2 to have a plan view area of 1 mm² or more, more preferably 4 mm² or more, and 100 mm² or less, more preferably 25 mm² or less. The same preference applies to the plan view area of the depressions 3. From the same point of view, the distances between adjacent protrusions 2 and between adjacent depressions 3 in the longitudinal direction X is preferably 1 mm or longer, more preferably 4 mm or longer, and is preferably 20 mm or shorter. The same preference applies to the distances between adjacent protrusions 2 and between adjacent depressions 3 in the transverse direction Y.

Whether a portion of the cleaning sheet 1 is a protrusion 2 or a depression 3 is decided by whether the position of the top of that portion is above or below a position at which the distance between the top of the protrusions 2 (the top of protrusions 2 on the first side 1a) and the bottom of the depressions 3 (the top of protrusions 2 on the second side 1b) in the thickness direction of the cleaning sheet 1 is divided into two halves. The shapes, sizes, arrangements, and the like of protrusions 2 and depressions 3 of the cleaning sheet 1 can be selected as desired by designing the pattern of engraving embossing rollers as will be appreciated from a hereinafter described preferred method for making the cleaning sheet 1.

As shown in FIG. 1, the cleaning sheet 1 of the invention has a number of linear bonds 15 where the fibers 13 making up the hydrophilic fiber aggregate 11 and the fibers 14 making up the hydrophobic fiber aggregate 12 are bonded together. As used herein, the term “bonded” is intended to mean that, when the fibers 13 include fusible fibers, the fibers are fusion bonded to one another or, when the fibers 13 do not include fusible fibers, for example, when the fibers 13 are rayon fibers, the fibers adhere to one another via fused fibers 14 of the hydrophobic fiber aggregates 12. As used herein, the term “linear” as in “linear bond 15” is intended to mean that the bond may have the form of a straight line as depicted in FIG. 1, or also may have a mixed form comprising a straight line and a curved line in a plan view. Each line may be a continuous line or a discontinuous line of a number of closely spaced rectangular, square, rhombic, circular, cross-shaped, or otherwise shaped bonds.

To prevent the cleaning sheet 1 from elongating in direction Y, it is preferred for the linear bond 15 to extend in a direction intersecting direction X. As shown in FIG. 1, the cleaning sheet 1 has a number of linear bonds 15 arranged in a lattice pattern. Specifically, the linear bonds 15 include a number of regularly spaced parallel first linear bonds 15a and a number of regularly spaced parallel second linear bonds 15b, the first linear bonds 15a intersecting the second linear bonds 15b at an angle α. The angle α is preferably 20° to 160°. The intersecting angle between, e.g., the second linear bonds 15b and direction X is preferably approximately half the angle α, specifically 10° to 80°. When a number of linear bonds 15 are provided in a lattice pattern like this, elongation of the cleaning sheet 1 in direction Y is further prevented, and the regions surrounded by the first and second linear bonds 15a and 15b undergo little change in shape of the protrusions 2 and the depressions 3. The width W1 of the first linear bonds 15a and the width of the second linear bonds 15b are equal, and the distance W2 between adjacent first linear bonds 15a and the distance between adjacent second linear bonds 15b are also equal.

In order to securely bond the fibers in the first and second linear bonds 15a and 15b without sacrificing the dust trapping performance of the cleaning sheet 1, the bonding width W1 of the first and second linear bonds 15a and 15b is preferably 0.3 mm or more, more preferably 0.5 mm or more, and 5 mm or less, more preferably 3 mm or less.

The distance W2 between adjacent first linear bonds 15a and between adjacent second linear bonds 15b is, in the case of the lattice pattern as in the cleaning sheet 1, preferably 10 mm or more, more preferably 13 mm or more, and 40 mm or less, more preferably 30 mm or less. W1 and W2 are measured in a direction perpendicular to the lines.

In the cleaning sheet 1, the linear bonds 15 intersect imaginary lines IL connecting the tops of two protrusions 2 adjacent to each other at the shortest distance as shown in FIG. 1. This will be described with specific reference to the first side 1a of the cleaning sheet 1. The imaginary lines IL are formed in a lattice pattern similarly to the linear bonds 15, and include a number of regularly spaced parallel first imaginary lines ILa and a number of regularly spaced parallel second imaginary lines ILb. As shown in FIG. 1, the first imaginary lines ILa of the cleaning sheet 1 are not parallel to the first linear bonds 15a (of the linear bonds 15), and make an intersecting angle γ with the first linear bonds 15a. The angle γ is preferably 3° to 30°. Similarly, as shown in FIG. 1, the second imaginary lines ILb are not parallel to the second linear bonds 15b (of the linear bonds 15), and make an intersecting angle 8 with the second linear bonds 15b. The angle 8 is preferably 3° to 30°. That is, in the cleaning sheet 1, every first linear bond 15a and every second linear bond 15b intersect the first imaginary line ILa and the second imaginary line ILb. With the linear bonds 15 intersecting the imaginary lines IL in that way, the number of the depressions 3 that overlap the linear bond 15 (15a or 15b) is reduced, so that reduction in dust trapping performance may be reduced, the protrusions 2 and the depressions 3 may be utilized more effectively, and the linear bonds 15 (15a and 15b) serve as guide paths that facilitate dust trapping by the depressions 3.

As shown in FIGS. 1 and 3, the cleaning sheet 1 has raised fibers raised from the surfaces of a plurality of the protrusions 2 and the surfaces of a plurality of the depressions 3. As used herein, the term “raised fibers” specifically indicates (i) the fibers 14 constituting the hydrophobic fiber aggregate 12 or (ii) the fibers 14 constituting the hydrophobic fiber aggregate 12 and the fibers 13 constituting the hydrophilic fiber aggregate 13. The cleaning sheet 1 has the fibers 14 (or the fibers 14 of the hydrophobic fiber aggregate 12 and the fibers 13 of the hydrophilic fiber aggregate 11) raised from the surface of the protrusions 2 and the surface of the depressions 3. As used therein, the term “raised” is intended to include a state of a fiber a free end of which sticks out of the surface of the sheet and a state of a fiber drawn out of the surface of the sheet in loop form (a free end of the fiber does not show up).

In the case of the cleaning sheet 1 of the present embodiment, the fibers raised from the surfaces of the protrusions 2 and the depressions 3 are for the most part the fibers 14 making up the hydrophobic fiber aggregate 12 provided on both sides 11a and 11b of the hydrophilic fiber aggregate 11. Therefore, the raised fiber(s) will be described with particular reference to the fiber(s) 14 of the hydrophobic fiber aggregate 12. In measuring the number or length of raised fibers, measurement is taken without distinguishing between the raised fibers 13 of the hydrophilic fiber aggregate 11 and the raised fibers 14 of the hydrophobic fiber aggregate 12 even when the raised fibers include the fiber 13.

The cleaning sheet 1 has both a raised fiber a free end of which sticks out and a raised fiber having a loop form (hereinafter also referred to as a raised loop fiber). In detail, the cleaning sheet 1 has more raised fibers 14 raised from the surface of the depressions 2 (raised fibers of the depressions 3) than those raised from the surface of the protrusions 2 (raised fibers of the protrusions 2). The number of the raised fibers 14 (the number of the raised fibers) is the number of raised fibers sticking out of the surface of the protrusions 2 or the depressions 3 in a natural state of the cleaning sheet 1 and does not include the number of raised fibers 14 drawn or pulled out from the surface of the protrusions 2 or the depressions 3. As will be described in detail with respect to the method for making the cleaning sheet 1, raising is carried out before three-dimensional texturing. Therefore, the degree of raising (e.g., the number of raised fibers) is uniform immediately after the raising process. However, as will be described later, the method for making the cleaning sheet 1 involves, after the raising process, the steps of texturing, taking up the textured sheet into roll, and further processing to provide a stack of finished products. During these steps, the raised fibers 14 located on the protrusions 2 are collapsed, whilst the raised fibers 14 located in the depressions 3 retain the raised state. As a result, the cleaning sheet 1 in its natural state has a larger number of apparent raised fibers 14 located in the depressions 3 as drawn in FIG. 3.

The height (h2) of the raised fiber 14 on the protrusion 2 (the raised fiber of the protrusion 2) is preferably 0.1 mm or more, more preferably 0.5 mm or more, and 30 mm or less, more preferably 20 mm or less. The height (h3) of the raised fiber 14 in the depression 3 (the raised fiber of the depression 3) is preferably 0.1 mm or more, more preferably 0.5 mm or more, and 30 mm or less, more preferably 20 mm or less.

The number of the raised fibers 14 on the protrusion 2 (the raised fibers of the protrusion 2) is preferably 5 or greater, more preferably 10 or greater, and 80 or fewer, more preferably 70 or fewer, per 10 mm width. The number of the raised fibers 14 in the depression 3 (the raised fibers of the depression 3) is preferably 5 or greater, more preferably 10 or greater, and 100 or fewer, more preferably 90 or fewer, per 10 mm width.

It is preferred for the cleaning sheet 1 to have more raised fibers 14 on the surface of the depressions 3 (raised fibers of the depressions 3) than on the surface of the protrusions 2 as shown in FIG. 3. The effect of having more raised fibers in the depressions 3 than on the protrusions 2 is that dust trapped in the depressions is more easily entangled with the raised fibers and retained there during a cleaning operation.

The height and number of the raised fibers 14 are measured by the method below.

### Preparation of Sample:

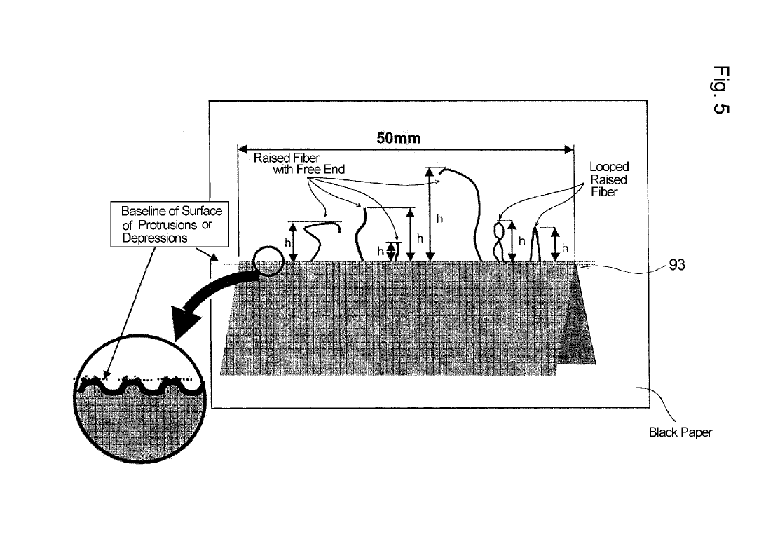

Two samples large enough (about 60 to 70 mm in the CD and about 50 mm in the MD) to allow for observation over a measuring length of 50 mm are cut out of the cleaning sheet 1. Each sample is folded into halves in a direction perpendicular to the MD and fixed on a sheet of black paper as shown in FIG. 5. The folding line should be at such a position that allows an observer to see the profile of the surface texture of the sample. Such a folding line passes almost the center of a plurality of protrusions and a plurality of depressions. The folded edge is lightly brushed five times using a brush (general-purpose brush No. 812 30 mm available from Komeri Co., Ltd.) in a direction from the sample to the black paper to make the raised fibers easily observable. The brushing force applied during brushing to the area 93 to be observed is controlled within a range of from 5 to 15 gf. The brushing force is adjusted by reference to the readings of a measuring scale.

### Measurement of Number and Height of Raised Fibers:

The sample folded in halves is observed using a digital microscope (VHX-500 from Keyence) at a magnification of 20 times. Measurement is taken using a vertical mode of measurements modes of the digital microscope as shown in FIG. 6. After a baseline of a protrusion 2 or a valley (depression 3) is obtained, the height of the highest point of every raised fiber 14 is measured within the respective measuring ranges of the protrusion 2 and the depression 3. The height is measured to about tenths of a millimeter, and measured values of 0.1 mm or greater are collected. Measurement is taken on at least two samples (n≧2). The height and the number are measured of the raised fibers on all protrusions 2 and depressions 3 existing in the measuring length of 50 mm. The number of the raised fibers 14 on the protrusions 2 or in the depressions 3 is obtained as follows. Taking, for instance, the protrusions 2, the total number (TN) of the raised fibers on all the protrusions 2 existing on one side within the measuring length of 50 mm is obtained, and the total length (TL) of the measuring ranges of the protrusions 2 in which the number of raised fibers have been counted is obtained. From the TN and TL is calculated the number of raised fibers per 10 mm of the projections 2. Specifically, the number of raised fibers of the projections 2 is calculated from the formula:

The number of raised fibers 14 on protrusions 2 per 10 mm=TN×10/TL

The number of raised fibers 14 per 10 mm of depressions 3 is obtained in the same manner.

The height of a raised fiber 14 is the height of the highest point of the fiber from the baseline. The highest point of a raised fiber 14 is not always the free end of the fiber. In some cases, a looped portion of a raised fiber can be at the highest point.

In the case when a raised loop fiber 14 straddles a protrusion 2 and a depression 3, that fiber is reckoned as one on the protrusion 2 and as another one in the depression 3, and the height of that fiber is measured from the respective baselines of the protrusion 2 and the depression 3.

In the above described method for measurement, the height is measured of the raised fibers 14 (raised fibers) having a height of 0.1 mm or greater.

The above mentioned heights h2 and h3 are averages of measured values.

There tend to be more raised fibers 14 in the depressions 3 than on the protrusions 2. However, in the case where the constituent fibers include thick fibers, because the thick fibers have increased stiffness and are therefore less likely to be collapsed after being raised on the surface of the protrusions 2, the number of the raised fibers in the depressions 3 is not always greater than that on the protrusions 2. In such cases, the number of the raised fibers in the depressions 3 tends to be equal to that on the protrusions 2.

As the mixing ratio of thick fibers increases, the total number of fibers making up the fiber aggregate decreases compared with a fiber aggregate made up solely of thinner fibers, with the basis weight being equal. As a result, the number of raised fibers tends to decrease.

The raised fibers 14 are obtained by the above described measurements of the number and the height of raised fibers.

As shown in FIG. 5, the raised fibers 14 raised from the surface of the depressions 3 include raised fibers of loop form (raised loop fibers). As used herein, the term “raised fiber of loop form” or “raised loop fiber” denotes a raised fiber having no free end.

Explanations about the raised loop fibers raised from the surface of the depressions apply to the raised loop fibers raised from the surface of the protrusions. Raised loop fibers include those straddling the surface of a protrusion and a transitional portion from the protrusion to a depression, those straddling the surface of a depression and a transitional portion from the depression to a protrusion, and those straddling the surface of a protrusion and the surface of a depression.

The thickness of the cleaning sheet 1, i.e., the distance from the top of a protrusion 2 on the first side 1a to the top of a protrusion 2 on the second side 1b is preferably 0.5 mm or more, more preferably 1.0 mm or more, and 7.0 mm or less, more preferably 4.0 mm or less. The thickness of the cleaning sheet 1 is measured using, e.g., a thickness gauge FS-60DS from Daiei Kagaku Seiki MFG Co., Ltd. under a load of 0.3 kPa, which corresponds to the pressure applied when the cleaning sheet 1 is lightly pressed by a hand. The measuring area to be pressed in making measurement is 20 cm².

In the interests of bulkiness retention during use, the thickness of the cleaning sheet 1 measured under a load of 0.7 kPa, larger than the load recited above, is preferably 0.5 mm or more, more preferably 1.0 mm or more, and 6.0 mm or less, more preferably 3.0 mm or less. The load of 0.7 kPa nearly corresponds to the load applied when the cleaning sheet 1 attached to a cleaning implement is used to mop, e.g., a floor.

The cleaning sheet 1 preferably has a basis weight of 30 g/m² or more, more preferably 40 g/m² or more, and 110 g/m² or less, more preferably 80 g/m², in terms of sheet strength, dust trapping capacity, low strike-through of dust, production efficiency, and so on.

The hydrophilic fiber aggregate 11, which functions as a backbone material of the cleaning sheet 1, is made mainly of hydrophilic fibers in terms of water retentivity (water absorptivity) and may contain heat fusible fibers in terms of sheet strength and post-thermal bonding shape retention. The proportion of the hydrophilic fibers in the total fibers 13 constituting the hydrophilic fiber aggregate 11 is preferably at least 50 mass %, more preferably 60 mass % or more. It is most preferred for the hydrophilic fiber aggregate 11 be made up solely of hydrophilic fibers. The proportion of heat fusible fibers in the total fibers 13 constituting the hydrophilic fiber aggregate 11 is preferably 50 mass % or less, more preferably 40 mass % or less, and even more preferably the hydrophilic fiber aggregate 11 includes no heat fusible fibers.

Examples of the hydrophilic fiber aggregate 11 include hydroentangled nonwoven fabric, wet processed nonwoven fabric, air-through nonwoven fabric, and wet processed paper. A non-consolidated fiber web may be used to be united with the hydrophobic fiber aggregates 12.

Useful hydrophilic fibers are exemplified by absorbent rayon, cotton, and pulp. These kinds of hydrophilic fibers may be used either individually or in combination of two or more thereof.

The heat fusible fibers, if used in the hydrophilic fiber aggregate 11, are preferably conjugate fibers composed of a fusible component and a high melting component having a higher melting temperature than the fusible component, more preferably sheath/core conjugate fibers having a sheath of a fusible component and a core of a high melting component. Both the fusible component and the high melting component are preferably thermoplastic resins. Examples of the fusible component include polyethylene, polypropylene, polybutene-1, polypentene-1, and random or block copolymers thereof. They may be used either individually or in combination of two or more thereof. Examples of the high melting component include polyesters, such as polyethylene terephthalate and polybutylene terephthalate, and polyamides, such as nylon-6 and nylon-66.

The proportion of the hydrophilic fiber aggregate 11 in the cleaning sheet 1 is preferably 30 mass % or more, more preferably 40 mass % or more, and 75 mass % or less, more preferably 70 mass % or less, from the viewpoint of allowing for smooth absorption and transfer of water from the surface being cleaned, such as a floor surface, into the cleaning sheet 1 and prevention of absorbed water from going back onto the floor. From the same viewpoint, it is preferred for the hydrophilic fiber aggregate 11 to have a larger basis weight than the hydrophobic fiber aggregate 12 per side (hereinafter described). Specifically, when the hydrophilic fiber aggregate 11 is hydroentangled nonwoven fabric, a basis weight of the hydrophilic fiber aggregate 11 is preferably 20 g/m² or more, more preferably 30 g/m² or more, and 240 g/m² or less, more preferably 200 g/m² or less.

The hydrophobic fiber aggregate 12 defining each of the first side 1a and the second side 1b of the cleaning sheet 1 is made of fibers 14 mainly comprising hydrophobic synthetic fibers. It is a fiber layer formed by entanglement of the fibers 14 with themselves and superposed on the hydrophilic fiber aggregate 11. The hydrophobic fiber aggregate 12 is, as shown in FIG. 2, united to the hydrophilic fiber aggregate 11 in conformity to the profile of the three-dimensionally textured hydrophilic fiber aggregate 11 to provide the cleaning sheet 1 of nonwoven fabric form. Thus, the cleaning sheet 1 has, as a whole, a three-dimensional texture with protrusions 2 and depressions 3. In other words, the shapes of the protrusions 2 and depressions 3 of the cleaning sheet 1 are almost the same as those of the protrusions and depressions of the hydrophilic fiber aggregate 11.

The hydrophobic synthetic fibers that mainly constitute the hydrophobic fiber aggregate 12 may be any fibers commonly used to make various kinds of nonwoven fabric. Examples thereof are thermoplastic fibers prepared from synthetic resins including polyolefins, such as polyethylene (PE) and polypropylene (PP); polyesters, such as polyethylene terephthalate (PET) and polybutylene terephthalate (PBT); polyamides, such as Nylon® and nylon 6; and acrylic resins. The synthetic fibers may be made of a single resin or may be conjugate fibers composed of two or more resins having different melting temperatures. Examples of the conjugate fibers are sheath/core conjugate fibers composed of a sheath of a resin having a relatively low melting temperature (low melting resin) and a core of a resin having a relatively high melting temperature (high melting resin) and side-by-side conjugate fibers having a low melting resin and a high melting resin alternating in a given direction.

The hydrophobic fiber aggregate 12 on each side of the cleaning sheet 1 preferably has a basis weight of preferably 10 g/m² or more, and preferably 35 g/m² or less, more preferably 30 g/m² or less, in view of the limitation by production equipment, sheet strength, and dust and hair trapping performance as a cleaning sheet. The hydrophobic fiber aggregate 12 on the side 11a of the hydrophilic fiber aggregate 11 and that on the other side 11b may have the same or different basis weights.

The fibers making up the hydrophobic fiber aggregate 12 preferably have an average diameter of 5 μm or greater, more preferably 8 μm or greater, and 60 μm or smaller, more preferably 45 μm or smaller, in terms of bulkiness, dust scratching performance, and dust and hair trapping performance.

The hydrophobic fiber aggregate 12 is preferably made up of a mixture of two or more kinds of fibers 14 different in diameter such that the largest diameter is twice or more the smallest diameter in terms of bulkiness, dust scratching performance, and formation of large interfiber voids. The hydrophobic fiber aggregate 12 preferably contains 90 mass % or less, more preferably 70 mass % or less, and 10 mass % or more, more preferably 30 mass % or more, of fibers having a diameter of 5 μm or more and less than 20 μm (hereinafter also referred to as fine fibers). The hydrophobic fiber aggregate 12 preferably contains 10 mass % or more, more preferably 30 mass % or more, and 90 mass % or less, more preferably 70 mass % or less, of fibers having a diameter of 20 to 60 μm (hereinafter also referred to as thick fibers).

The thick fibers are preferably twice or more times, more preferably 2.5 times or more, as thick as the fine fibers in terms of suitability to production equipment, fiber entanglement, and dust scratching performance of the sheet.

The diameter of synthetic fibers is measured as follows.

### Method for Measuring Fiber Diameter:

Five fibers 14 are chosen at random from the hydrophobic fiber aggregate 12. The diameter of the chosen fibers is measured using a microscope. An average of the five measurement values is taken as the diameter of the fibers 14. When the hydrophobic fiber aggregate 12 contains two or more kinds of fibers 14 having different diameters, the fiber diameter is determined for each kind of fibers in accordance with the above described procedure.

It is also possible to obtain an approximate fiber diameter by calculation from the fineness according to the following formula:

dtex=πr²×10000×ρ×10⁻⁶

r=√(dtex/πρ×10⁻²));øμm=2r

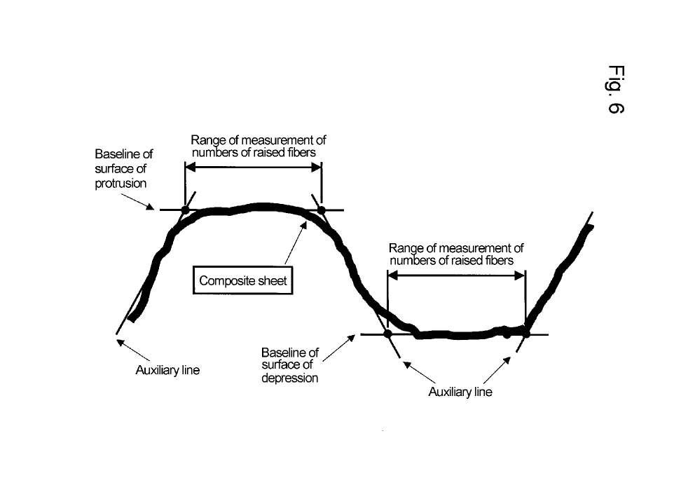

A preferred embodiment of the production of the cleaning sheet of the invention will then be described with reference to the production of the cleaning sheet 1 by way of FIGS. 7 through 10.

The method for producing the cleaning sheet of the invention starts with joining a hydrophobic fiber aggregate 12 of fiber web form onto each of the sides 11a and 11b of a hydrophilic fiber aggregate 11. The resulting stack of the fiber aggregates is subjected to high-pressure jets of water to entangle the fibers 13 of the hydrophilic fiber aggregate 11 with the fibers 14 of the hydrophobic fiber aggregate 12 thereby to unite the stack into a laminate 6. The laminate 6 is subjected to raising on both sides thereof, and the raised laminate 6′ is then textured three-dimensionally in a plurality of regions. The textured laminate 6″ is seal bonded to form linear bonds 15 at which the hydrophilic fiber aggregate 11 and the hydrophobic fiber aggregates 12 are bonded together to provide a cleaning sheet 1. The method will be described below in more detail.

FIG. 7 is a schematic illustration of a production apparatus 20 suitably used to carry out the method for making the cleaning sheet 1 of the present embodiment. The apparatus 20 is largely divided, from the upstream side toward the downstream side, into a joining part 20A, an entanglement part 20B, a raising part 20C, a texturing part 20D, a bonding part 20E, and cooling part 20F.

The arrows x in the drawings indicate the moving direction of the cleaning sheet 1 being produced, which is coincident with the MD (direction X) in which the fibers are aligned. The arrow y in the drawing indicates the axial direction of a rotating roller, which is coincident with the CD (direction Y).

As shown in FIG. 7, the joining part 20A includes, from the upstream side toward the downstream side, cards 21A and 21B for manufacturing fiber webs 12a and 12b, rollers 22 for feeding the fiber webs 12a and 12b, and a roller 24 for feeding a web of a hydrophilic fiber aggregate 11 from a stock roll 23 located between the cards 21A and 21B.

As shown in FIG. 7, the entanglement part 20B includes, from the upstream side toward the downstream side, a set of a web support belt 25A (endless belt) and water jet nozzles 26A for water-jet entangling the constituent fibers of the hereinafter described stack 5 from one side of the stack (upper side), a downstream another set of a web support belt 25B (endless belt) and water jet nozzles 26B for water-jet entangling the constituting fibers of the stack from the other side (lower side), and a dryer 27.

The raising part 20C is a part where the fibers of a hereinafter described laminate 6 (a precursor sheet of a cleaning sheet 1) are raised. As shown in FIG. 7, the raising part 20C includes, from the upstream side toward the downstream side, an engraved roller 31 having a plurality of projections 310 on its peripheral surface and an engraved roller 34 having a plurality of projections 340 on its peripheral surface. While the engraved rollers 31 and 34 are the same, the engraved roller 31 is a roller for raising one side of the hereinafter described united laminate 6, and the engraved roller 34 is a roller for raising the other side of the united laminate 6. The engraved rollers 31 and 34 are cylindrical members made of metal, such as an aluminum alloy or steel. Each of the engraved rollers 31 and 34 is rotated by a driving force transmitted from an unshown driving means to its axis of rotation. The rotational speed (peripheral velocity V3) of the engraved roller 31 and the rotational speed (peripheral velocity V4) of the engraved roller 34 are controlled by a controller (not shown) of the apparatus 20. The peripheral velocity V3 of the engraved roller 31 is the speed on the surface of the engraved roller 31. As used herein, the term “surface” of the engraved roller 31 is not an imaginary surface connecting the tips of the projections 310 but a surface at the base of the projections. Likewise, the peripheral velocity V4 of the engraved roller 34 means the speed on the surface of the engraved roller 34.

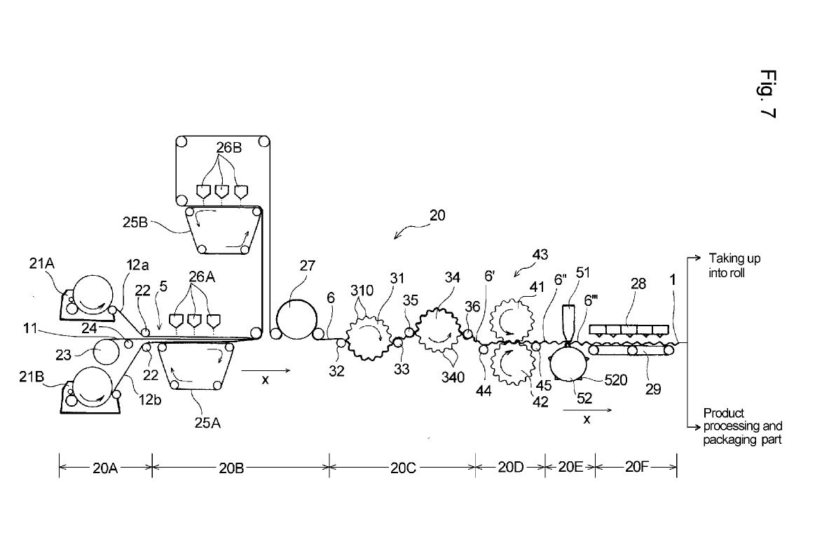

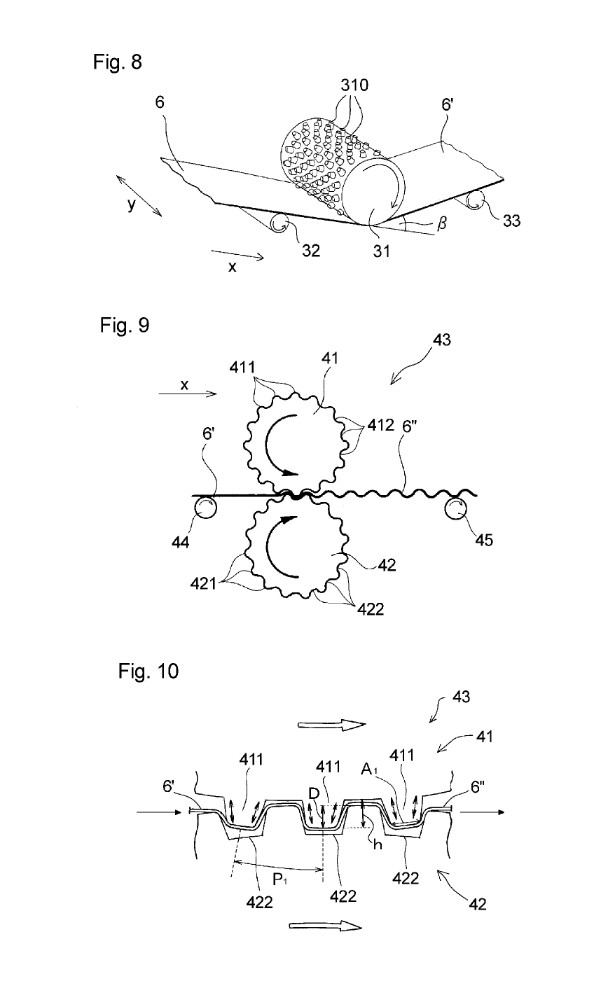

As shown in FIGS. 7 and 8, the raising part 20C has rollers 32 and 33 upstream and downstream, respectively, of the engraved roller 31 for transporting the laminate 6 to be subjected to raising to the engraved roller 31, and rollers 35 and 36 upstream and downstream, respectively, of the engraved roller 34 for transporting the raised laminate 6′ having a raised surface on one side thereof to the engraved roller 34. The transport rate V2 of the laminate 6 is controlled by the unshown controller of the apparatus 20. As used herein, the term “transport rate. V2” of the laminate 6 to be subjected to raising means the speed of the surface of the laminate 6 being fed to the engraved roller 31. Each of the rollers 32, 33, 35, and 36 is a free roller connected to no driving source but may be a motor powered roller.

The height of the individual projections 310 and 340 (see FIG. 8) of the engraved rollers 31 and 34 (the distance from the peripheral surface of the engraved roller 31 or 34 to the top of the projection 310 or 340) is preferably 0.01 mm or more and preferably 3 mm or less, more preferably 1 mm or less. The distance between adjacent projections (the pitch of the projections) 310 or 340 in the circumferential direction is preferably 0.01 mm or more and preferably 50 mm or less, more preferably 3 mm or less, and that in the axial direction is preferably 0.01 mm or more and preferably 30 mm or less, more preferably 3 mm or less. The number of the projections 310 and 340 per unit area is preferably 500 to 20000 per cm² in terms of providing many points of raising action to give a laminate 6′ with many raised fibers. The shape of the top of the individual projections 310 and 340 of the engraved rollers 31 and 34 is not particularly limited and may be, for example, a circular, polygonal, or oval shape. The area of the top of the individual projections 310 and 340 is preferably 0.001 mm² or more, more preferably 0.01 mm² or more, and 20 mm² or less, more preferably 1 mm² or less.

In order to raise the fibers of the laminate 6 more effectively with the apparatus 20 of the present embodiment, it is preferred that the position of the roller 33 downstream of the engraved roller 31 be higher than that of the engraved roller 31 so that the laminate 6 may be partially wrapped around the engraved roller 31 at a wrap angle β of 10° to 180°, more preferably 30° to 120° as shown in FIG. 8. It is preferred for the laminate 6 to contact with the engraved roller 34, too, at a wrap angle β.

As shown in FIGS. 7 and 9, the texturing part 20D is a part where a plurality of regions of the raised laminate 6′ are deformed thermally or plastically. In the apparatus 20 of the present embodiment, the texturing part 20D has a steel-to-steel matched embossing unit 43 composed of a pair of embossing rollers 41 and 42 as shown in FIGS. 7 and 9. The steel-to-steel matched embossing unit 43 is equipped with a heater (not shown) capable of heating to a predetermined temperature. As used herein, the terminology “thermal or plastic deformation” means that a thermoplastic resin, for example, is deformed on heating at or above its softening point and retains the deformed shape. The term “softening point” means the temperature at which a thermoplastic resin, for example, is deformable by a mechanical or other force.

The steel-to-steel matched embossing is characterized in that the two embossing rollers rotate not in contact interengagement with each other but with a clearance maintained therebetween by machine setting.

The pair of embossing rollers 41 and 42 are configured such that the roller 41 has a plurality of protrusions 411 on its peripheral surface, and the other roller 42 has, on its peripheral surface, recesses 422 at positions corresponding to the protrusions 411 of the roller 41 for receiving the protrusions 411. The pair of embossing rollers 41 and 42 are also configured such that the roller 42 has a plurality of protrusions 421 on its peripheral surface, and the other roller 41 has, on its peripheral surface, recesses 412 at positions corresponding to the protrusions 421 of the roller 42 for receiving the protrusions 421 of the roller 42. Both the embossing rollers 41 and 42 have the protrusions 411 (and 421) and the recesses 412 (and 422) arranged on their peripheral surface in a staggered pattern. The embossing rollers 41 and 42 used in the apparatus 20 of the present embodiment are the same, except for having their protrusions 411 (and 421) arranged at positions corresponding to the recesses 422 (and 412) of the respective mating rollers. Therefore, the description below will generally be confined to the protrusions 411 of the embossing roller 41 and the recesses 412 of the embossing roller 42.

The paired rollers 41 and 42 are cylindrical members made of metal, such as an aluminum alloy or steel. As shown in FIG. 10, the steel-to-steel matched embossing unit 43 of the apparatus 20 of the present embodiment is configured such that the plurality of protrusions 411 on the peripheral surface of the roller 41 and the plurality of recesses 422 on the peripheral surface of the roller 42 are in contactless relation in their full engagement. The protrusions 411 are uniformly and regularly arranged in both the axial direction and the circumferential direction of the roller 41. The pair of rollers 41 and 42 rotate by a driving force transmitted from unshown driving means using unshown gears. From the viewpoint of avoiding collapse of the raised state, it is preferred to transmit a driving force by using gears. The rotational speed of the paired rollers 41 and 42 is controlled by the unshown controller of the apparatus 20.

The shape of the individual protrusions 411 on the peripheral surface of the roller 41 when viewed from above may be circular, square, elliptic, rhombic, or rectangular (oblong in the MD or the CD) and is preferably circular in view of minimizing reduction in strength of the raised laminate 6′. The shape of the individual protrusions 411 when viewed from the side may be trapezoidal, square, or convex and is preferably trapezoidal in view of reduced abrasion during rotation. The bottom angle of a trapezoidal protrusion preferably ranges from 70° to 89°. The portion of the protrusions 411 with which the laminate 6′ comes into contact may previously be textured with fine unevenness so that the surface of the deformed laminate 6″ may be raised or may recover the raised state when separated apart from the roller 41.

In the texturing part 20D, it is preferred that the height h (see FIG. 10) of each protrusion 411 of the roller 41 measured from the peripheral surface of the roller 41 to the top of the protrusion 411 be 1 mm or more, more preferably 2 mm or more, and 10 mm or less, more preferably 7 mm or less; the distance between protrusions 411 adjacent in the circumferential direction (pitch P₁) be 0.01 mm or more, more preferably 1 mm or more, and 20 mm or less, more preferably 6 mm or less; and the distance between protrusions 411 adjacent in the axial direction (pitch P₂ (unshown)) be 0.01 mm or more, more preferably 1 mm or more, and 20 mm or less, more preferably 6 mm or less. The distance of the protrusions 411 adjacent in the circumferential direction (pitch P₁) is obtained by measuring the arc length of the roller 41. The shape of the top of each protrusion 411 of the roller 41 is not particularly limited and may be, for example, a circular, polygonal, or oval shape. The area of the top of each protrusion 411 is preferably 0.01 mm² or more, more preferably 0.1 mm² or more, and 500 mm² or less, more preferably 10 mm² or less. The area of the bottom between adjacent protrusions 411 is preferably 0.01 mm² or more, more preferably 0.1 mm² or more, and 500 mm² or less, more preferably 10 mm² or less. Each protrusion 411 preferably has a rounded edge. When the protrusion 411 has a rounded edge, the area of the top of the protrusion 411 is obtained as a projected area of the shape delineated by the centerline of the width of the rounded edge viewed from above.

In the texturing part 20D, the recesses 422 of the roller 42 are arranged at positions corresponding to the protrusions 411 of the roller 41 as shown in FIGS. 9 and 10. As shown in FIG. 10, the depth D of engagement between the projections 411 of the roller 41 and the projections of the roller 42 (the length of the overlap between the projection 411 and the recess 422) is preferably 0.1 mm or more, more preferably 1 mm or more, and 10 mm or less, more preferably 8 mm or less. It is preferred that there be a clearance between the top of the protrusion 411 of the roller 41 and the bottom of the recess 422 of the roller 42 so that the raised laminate 6′ passing through the nip therebetween may not be pressed by the engagement and may thereby be prevented from eliminating the raised state.

As shown in FIGS. 7 and 9, the texturing part 20D further includes rollers 44 and 45 upstream and downstream, respectively, of the steel-to-steel matched embossing unit 43 for conveying the raised laminate 6′ to the steel-to-steel matched embossing unit 43.

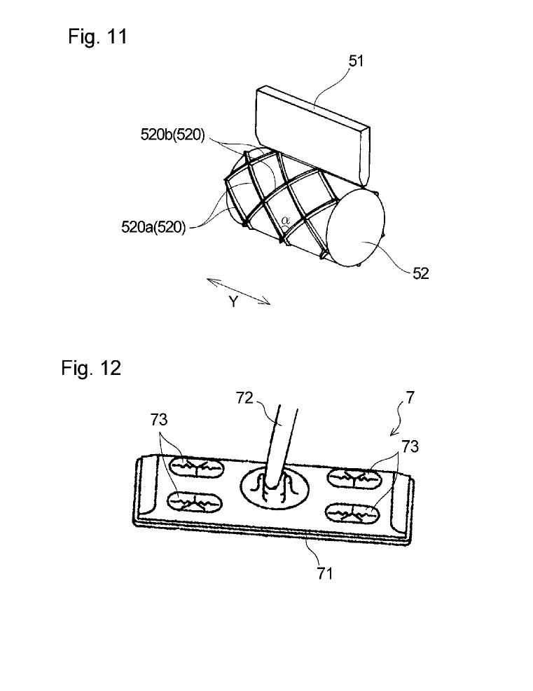

The bonding part 20E is a part where the textured laminate 6″ is seal bonded as shown in FIGS. 7 and 11. As shown, the bonding part 20E of the apparatus 20 according to the present embodiment includes an ultrasonic hone 51 and a patterning roller 52. While the apparatus 20 of the present embodiment adopts an ultrasonic welding process using the ultrasonic horn 51 and the patterning roller 52, the seal-bonding may be performed by heat sealing using a heat sealing roller. As shown in FIG. 11, the patterning roller 52 is a cylindrical member made of metal, such as an aluminum alloy or steel, and having, on its peripheral surface, ridges 520 corresponding to the linear bonds 15 of the cleaning sheet 1 to be produced. The ridges 520 include first ridges 520a corresponding to the first linear bonds 15a of the cleaning sheet 1 and second ridges 520b corresponding to the second linear bonds 15b of the cleaning sheet 1. The patterning roller 52 is rotated by a driving force transmitted from unshown driving means by means of unshown gears.

The rotational speed of the patterning roller 52 is controlled by the unshown controller of the apparatus 20.

The ridges 520 on the peripheral surface of the patterning roller 52 preferably have a height h1 from the peripheral surface of the patterning roller 52 to the top of the ridge 520 of 1 mm or more, more preferably 2 mm or more, and 10 mm or less, more preferably 8 mm or less from a standpoint of preventing the protrusions and depressions of the textured laminate 6″ from collapsing. As stated above, since the first ridges 520a and the second ridges 520b correspond to the first linear bonds 15a and the second linear bonds 15b, respectively, the first and second ridges 520a and 520b are in an arrangement that satisfies the above discussed criteria about the angle α between the first linear bonds 15a and the second linear bonds 15b and the width W2 between the first linear bonds 15a and between the second linear bonds 15b, and the width of the top of the first and the second ridges 520a and 520b is such that satisfies the above discussed criterion about the width W1 of the first and the second linear bonds 15a and 15b.

The cooling part 20F includes, as shown in FIG. 7, an air blower duct 28 in front of one side of a laminate 6′″ as obtained after the uniting by bonding and a vacuum conveyor 29 on the other side of the laminate 6′″. Cool air is blown through the air blower duct 28 to the laminate 6′″. The vacuum conveyor 29 is an endless mesh belt conveying the laminate 6′″. The vacuum conveyor 29 is configured such that the cool air blown from the air blower duct 28 is sucked through the mesh belt. The cooling part 20F is not limited to the structure above and may have other cooling means, such as a water-cooled roller having cooling water circulating therethrough or a vacuum roller capable of sucking air inside through its peripheral surface. Blowing air from the air blower duct is also expected to be effective in re-raising fibers that have been raised but laid down in the preceding texturing process.

The method for making the stretch sheet 1 will then be described based on an embodiment in which the above described apparatus 20 is used. FIGS. 7 through 11 are referred to.

In the joining part 20A, fiber webs 12a and 12b, each of which is a precursor of a hydrophobic fiber aggregate, are fed continuously from the cards 21A and 21B, respectively, by means of the respective feed rollers 22. On the other hand, a hydrophilic fiber aggregate 11 in the form of nonwoven fabric is taken off the stock roll 23 placed between the cards 21A and 21B by means of the feed roller 24. The fiber webs 12a and 12b are superposed on the respective sides of the hydrophilic fiber aggregate 11 by means of the rollers 22 to make a stack 5.

High-pressure water jets are applied to both sides of the stack 5 composed of the hydrophilic fiber aggregate 11 and the hydrophobic fiber aggregates, one on the side 11a and the other on the side 11b of the hydrophilic fiber aggregate 11 to cause the fibers 14 of the hydrophobic fiber aggregates 12 to entangle with the fibers 13 of the hydrophilic fiber aggregate 11, thereby to unite the stack 5. In detail, in the entanglement part 20B, the stack 5 is transferred onto the web support belt 25 and conveyed to be subjected to hydroentanglement by high-pressure water jets applied from the water jet nozzles 26A and 26B to both sides thereof. As a result, the fibers 14 of each of the fiber webs 12a and 12b are entangled with one another to form a fiber layer as a hydrophobic fiber aggregate 12, which becomes the surface layer of the cleaning sheet 1. At the same time, the fibers 14 of the hydrophobic fiber aggregate 12 enter the hydrophilic fiber aggregate 11 and are entangled with the fibers 13 to provide a laminate 6 in which the three fiber layers are united together, which is then passed through the dryer 27 to give a water-free laminate 6. The resulting united laminate 6 is a precursor sheet of the cleaning sheet 1 to be produced.

Both sides of the united laminate 6 are then subjected to a raising process. In detail, in the raising part 20C, the fibers 14 constituting the laminate 6, i.e., the fibers 14 of the hydrophobic fiber aggregate 12 forming the precursor sheet of the cleaning sheet 1 (or both the fibers 14 of the hydrophobic fiber aggregate 12 and the fibers 13 of the hydrophilic fiber aggregate 11) are raised from the surface of the precursor sheet to expose the end of the fibers 14. In the present embodiment, as shown in FIG. 7, the laminate 6 is fed by the rollers 32 and 33 to the engraved roller 31 having the projections 310 on its peripheral surface. The engraved roller 31 rotating in the direction indicated in FIG. 7 scratches and raises the fibers 14 on one (upper) side of the hydrophobic fiber aggregate 12 that forms the laminate 6 to expose the end of the raised fibers 14 on that side. The laminate 6 having one side raised is then forwarded by the rollers 35 and 36 to the engraved roller 34 having the projections 340 on its peripheral surface. The engraved roller 34 rotating in the direction indicated in FIG. 7 raises the fibers 14 on the other (lower) side of the hydrophobic fiber aggregate 12 that forms the laminate 6 to expose the end of the raised fibers 14 on that side. Depending on the state of the hydrophilic fiber aggregate 11 in the laminate or the integrity of the laminate, the fibers 13 constituting the hydrophilic fiber aggregate 11 may also be raised on one (upper) side or the other (lower) side of the laminate.

In the present embodiment, in order to efficiently raise the fibers 14 from the surfaces of the laminate 6 to give a laminate 6′ with reduced neck-in or wrinkles, it is preferred that the engraved roller 31 rotate in a direction reverse to the moving direction x of the laminate 6 as shown in FIGS. 7 and 8. In this counter-rotation mode, the value V3 (peripheral velocity of the engraved roller 31) divided by V2 (transport rate of the laminate 6), V3/V2, is preferably 0.3 to 20, more preferably V3>V2. In view of sufficient raising and reduced tangle of the fibers in the roller, the value V3/V2 is more preferably 1.1 or greater, even more preferably 1.5 or greater, and 15 or smaller, even more preferably 12 or smaller. To rotate the roller 31 in the reverse direction and to provide a difference of the peripheral velocity increase the amount of fiber raising. When, on the other hand, the engraved roller 31 rotates in the forward direction (the moving direction x of the laminate 6), the transport rate V2 of the laminate 6 and the peripheral velocity V3 of the engraved roller 31 are preferably related such that the value V3/V2 be 1.1 or greater, more preferably 1.5 or greater, even more preferably 2 or greater, and 20 or smaller, more preferably 10 or smaller, even more preferably 8 or smaller.

The preference about the direction of rotation of the engraved roller 31 also applies to the engraved roller 34. The roller 34 is preferably rotated in a direction reverse to the moving direction x of the laminate 6. In this counter-rotation mode, the value V4 (peripheral velocity of the engraved roller 34) divided by V2 (transport rate of the laminate 6), V4/V2, is preferably 0.3 to 20, more preferably V4>V2. In view of sufficient raising and reduced tangle of the fibers in the roller, the value V4/V2 is more preferably 1.1 or greater, even more preferably 1.5 or greater, and 15 or smaller, even more preferably 12 or smaller. To rotate the roller 34 in the reverse direction and to provide a difference of the peripheral velocity increase the amount of fiber raising. When, on the other hand, the engraved roller 34 rotates in the forward direction (the moving direction x of the laminate 6), the transport rate V2 of the laminate 6 and the peripheral velocity V4 of the engraved roller 34 are preferably related such that the value V4/V2 be 1.1 or greater, more preferably 1.5 or greater, even more preferably 2 or greater, and 20 or smaller, more preferably 10 or smaller, even more preferably 8 or smaller.

The raised state of fibers is adjustable as desired by the speed of roller rotation and the shape of the engraved roller. That is, the raised state of fibers is adjustable as desired by either altering the peripheral velocity ratio by changing the condition of the engraved roller or altering the geometry of the engraved roller with the peripheral velocity ratio being fixed. As used herein, the term “raised state” refers to the number and the height of raised fibers.

Subsequently, texturing is applied to a plurality of regions of the raised laminate 6′. In detail, in the texturing part 20D, three-dimensional surface texturing is applied to each of a plurality of regions of the raised laminate 6′ to provide the raised laminate 6′ with a plurality of protrusions 2 and a plurality of depressions 3. In the present embodiment, the raised laminate 6′ is introduced by the rollers 44 and 45 into the nip of the pair of rollers 41 and 42 of the steel-to-steel matched embossing unit 43 installed in the texturing part 20D to be deformed as shown in FIGS. 7 and 9. Specifically, the laminate 6′ conveyed by the rollers 44 and 45 is pressed between the plurality of protrusions 411 of one of the paired rollers (i.e., the roller 41) and the plurality of recesses 422 of the other roller (i.e., the roller 42) shown in FIGS. 9 and 10, whereby the laminate 6′ undergoes deformation in the plurality of regions along the moving direction x and the transverse direction y perpendicular to the moving direction to become a deformed laminate 6″. The thus deformed laminate 6″ has a three-dimensional texture corresponding to the peripheral surface profile of the roller 41.

In order to set the deformation on the raised laminate 6′ in conformity to the surface profile of the rollers 41 and 42 to provide the laminate 6″ with good cushioning properties and to raise the fibers in the depressions, too, of the surface texture to provide the laminate 6″ with excellent dust trapping capabilities in the texturing part 20D, the deformation is preferably effected at a temperature at or above the softening point of the fibers making up the hydrophilic fiber aggregate 11, which is the backbone material of the laminate 6′. It is also effective to carry out the deformation at or above the melting temperature of the fibers. The hydrophilic fiber aggregate 11 will thereby be deformed securely to have protrusions and depressions and retain the deformation more stably.

In the texturing part 20D, the texturing is preferably carried out under such a condition that does not cause the hydrophobic fiber aggregates 12 (fiber webs 12a and 12b) of the raised laminate 6′ to reduce their dust trapping performance. When, for example, the fibers 14 of the hydrophobic fiber aggregates 12 (fiber webs 12a and 12b) contain thermoplastic synthetic fibers, the deformation process may reduce the dust trapping capabilities of the hydrophobic fiber aggregates 12 (fiber webs 12a and 12b) if conducted at a temperature at which the thermoplastic synthetic fibers melt. Then, it is advisable to carry out the deformation in the texturing part 20D at a temperature below the melting temperature of the thermoplastic synthetic fibers of the fibers 14 so as to avoid possible reduction in dust trapping performance.

The textured laminate 6″ is subjected to a seal bonding process to form linear bonds 15, at which the hydrophilic fiber aggregate 11 and the hydrophobic fiber aggregates 12 are bonded together, to provide a seal-bonded laminate 6′″. In detail, in the bonding part 20E, as shown in FIGS. 7 and 11, the textured laminate 6″ is conveyed between the ultrasonic horn 51 and the patterning roller 52 and undergoes welding to form linear bonds 15 (including first linear bonds 15a and second linear bonds 15b) in conformity to the ridges 520 (including first ridges 520a and second ridges 520b) formed on the peripheral surface of the patterning roller 52. As a result, the hydrophilic fiber aggregate 11 and the hydrophobic fiber aggregate 12 on each side of the hydrophilic fiber aggregate 11 are bonded and united together at the linear bonds 15 (first linear bonds 15a and second linear bonds 15b). The ultrasonic welding involves less residual heat than heat sealing using a pair of heat rollers and is therefore less likely to deform the three-dimensional texture.

The laminate 6′″ as obtained after deformation in the texturing part 20D and welding in the bonding part 20E has an increased temperature due to the deformation and welding processes. If the increased temperature is maintained after the bonding, there is a possibility that the hydrophilic fiber aggregate 11 having gained a three-dimensional structure can reduce its bulkiness. Therefore, the laminate 6′″ is cooled through the cooling part 20F to permanently set the three-dimensional structure of the hydrophilic fiber aggregate 11 in the laminate 6′″ thereby producing the cleaning sheet 1 in a continuous manner. Depending on the deformation condition (e.g., when the heating temperature is low), the cooling part 20F may be unnecessary. In such a case, the raised laminate is subjected to a seal bonding process to continuously produce the cleaning sheet 1.

The thus produced cleaning sheet 1 of continuous form is usually taken up into a roll and stored in roll form as described in FIG. 7. While being stored in roll form, the fibers raised from the surface of the protrusions 2 of the cleaning sheet 1 are liable to be collapsed. As a result, the cleaning sheet 1 in its natural state has more apparent raised fibers 14 on the surface of the depressions 3 (raised fibers in the depressions 3) than on the surface of the protrusions 2 (raised fibers on the protrusions 2) as drawn in FIG. 3.

Even when the cleaning sheet 1 of continuous form as produced is folded, stacked, or otherwise processed in a product processing and packaging part described in FIG. 7, the fibers raised from the surface of the protrusions 2 of the cleaning sheet 1 are liable to be collapsed. In such a case, too, the cleaning sheet 1 in its natural state has more apparent raised fibers 14 on surface of the depressions 3 (raised fibers in the depressions 3) than on the surface of the protrusions 2 (raised fibers on the protrusions 2) as shown in FIG. 3.

According to the method for making the cleaning sheet 1 of the present embodiment, even when the texture of the cleaning sheet 1 is once collapsed while the cleaning sheet 1 is stored in roll form or finished product form, the texture may be restored, or the fibers laid down on the surface of the protrusions 2 may be re-raised by, for example, applying hot air when the cleaning sheet 1 is used.

The resulting cleaning sheet 1 is used as a cleaning sheet for dry mopping as stated earlier. It is also usable as a cleaning sheet for wet mopping after previously applying a finishing oil and the like according to the intended use. The finishing oil preferably contains at least one of mineral oils, synthetic oils, silicone oils, and surfactants. Examples of useful mineral oils are paraffinic hydrocarbons, naphthenic hydrocarbons, and aromatic hydrocarbons. Examples of useful synthetic oils are alkylbenzene oils, polyolefin oils, and polyglycol oils. Examples of useful silicone oils include linear dimethylpolysiloxanes, cyclic dimethylpolysiloxanes, methylhydrogen polysiloxanes, and various modified silicones. Examples of useful surfactants include cationic surfactants, such as mono(long-chain alkyl)trimethylammonium salts, di(long-chain alkyl)dimethylammonium salts, and mono(long-chain alkyl)dimethylbenzylammonium salts each having a C10-C22 alkyl or alkenyl group; and nonionic surfactants, including polyethylene glycol ethers, such as polyoxyethylene (6-35 mol) long-chain (primary or secondary C8-C22) alkyl or alkenyl ethers and polyoxyethylene (6-35 mol) (C8-C18) alkyl phenyl ethers, polyoxyethylene polyoxypropylene block copolymers, and polyhydric alcohol surfactants, such as glycerol fatty acid esters, sorbitol fatty acid esters, and alkyl glycosides. The step of applying the finishing oil may be either before or after the texturing part 20D.

When used for cleaning, the cleaning sheet 1 is attached to a cleaning implement 7 shown in FIG. 12. The cleaning implement 7 includes a head 71 and a handle 72 connected to the head 71, and the cleaning sheet 1 is attached to the head 71. The lower side (the side to be covered with the cleaning sheet 1) of the head 71 is oblong rectangular in a plan view. The cleaning sheet 1 is attached in a manner such that, for example, direction X of the cleaning sheet 1 in which the constituent fibers are aligned coincides with the longitudinal direction of the head 71. In attaching, the cleaning sheet 1 is placed under the lower side of the head 71 with its raised side out (facing an object to be cleaned), and both side margins of the cleaning sheet 1 are folded onto the upper side of the head 71 and pressed into a plurality of flexible, sated attachment means 73 to be secured. The cleaning implement 7 with the cleaning sheet 1 attached thereto is used, in usual mode of use, by moving the head 71 in the width direction of the head 71 commonly in a forward and backward motion to achieve a cleaning operation. That is, the cleaning direction of the cleaning implement 7 is the width direction of the head 71, which is direction Y of the cleaning sheet 1. The cleaning implement 7 having the cleaning sheet 1 attached thereto is used to mopping or wiping hard surfaces of floors, walls, ceilings, glass panes, tatami, mirrors, furniture, appliances, exterior walls, car bodies, and so forth.

While the cleaning implement 7 with the cleaning sheet 1 attached thereto is being used to mop a floor, since the hydrophilic fiber aggregate 11 and the hydrophobic fiber aggregates 12 are bonded along the linear bonds 15, the cleaning sheet 1 hardly elongates and is thereby prevented from causing inconveniences, such as coming off a sweeper. When, in particular, the linear bonds 15 are provided in a direction intersecting direction X, the cleaning sheet 1 hardly elongates in direction Y and is further prevented from coming off a sweeper.

Even when a user finds some water sprinkled on the floor during mopping using the cleaning implement 7 with the cleaning sheet 1 attached thereto, the water can be absorbed by the dry mopping. Since the cleaning sheet 1 is constructed by the fibers 14 of the hydrophobic fiber aggregate 12 entering the inside of the hydrophilic fiber aggregate 11 and entangled with the fibers 13 of the hydrophilic fiber aggregate 11 as appreciated from FIGS. 3 and 4, water once absorbed is wicked smoothly into the inner hydrophilic fiber aggregate 11. Water once absorbed is thus prevented from migrating from the inside hydrophilic fiber aggregate 11 to the hydrophobic fiber aggregate 12, which is composed mainly of hydrophobic synthetic fibers disposed on both sides of the hydrophilic fiber aggregate 11, and from returning back to the floor surface.

When the cleaning implement 7 with the cleaning sheet 1 attached thereto is used to mop a floor, because the cleaning sheet 1 is three-dimensionally textured with a plurality of protrusions 2 and a plurality of depressions 3 as shown in FIG. 1, and also because the fibers 14 are raised from the surface of not only the protrusions 2 but the depressions 3, the cleaning sheet 1 is capable of trapping hair or fluffy dust efficiently and holding particulate dust in the depressions 3. The particulate dust held in the depressions 3 are caught by the fibers 14 and thereby prevented from falling from the depressions 3 to accomplish improved dust trapping efficiency.

When the cleaning implement 7 with the cleaning sheet 1 attached thereto is used to mop a floor, since the cleaning sheet 1 is three-dimensionally textured with a plurality of protrusions 2 and a plurality of depressions 3 as shown in FIG. 1, improved dirt trapping performance, particularly improved fluffy dust retaining performance while wet is achieved. Furthermore, the cleaning sheet 1 has improved convenience in attaching to the cleaning implement 7 because of the three-dimensional texture of the cleaning sheet 1.

The invention is by no means limited to the aforementioned embodiments.

For example, while the cleaning sheet 1 has the hydrophobic fiber aggregate 12 made mainly of hydrophobic synthetic fibers directly joined to each side 11a, 11b of the hydrophilic fiber aggregate 11 made mainly of hydrophilic fibers as shown in FIG. 1, it is possible to provide a mesh sheet on at least one side of the hydrophilic fiber aggregate 11, via which the hydrophobic fiber aggregate 12 is superposed, so as to provide increased strength and prevent elongation. Such a mesh sheet may be resin-made lattice net. The strand thickness of the mesh sheet is preferably 50 μm or more, more preferably 100 μm or more, and 600 μm or less, more preferably 400 μm or less. The distance between adjacent strands is preferably 2 mm or more, more preferably 4 mm or more, and 30 mm or less, more preferably 20 mm or less. The mesh sheet may or may not be heat shrinkable.

Examples of the material of the mesh sheet include those described in U.S. Pat. No. 5,525,397, col. 3, ll. 39-46. Various thermoplastic resins are particularly preferred. In order for the cleaning sheet 1 to be capable of retaining its bulkiness even with a load applied thereon, the mesh sheet is preferably of an elastic material. Examples of suitable materials of the mesh sheet include polyolefin resins, such as polyethylene, polypropylene, and polybutene; polyester resins, such as polyethylene terephthalate and polybutylene terephthalate; polyamide resins, such as nylon; acrylonitrile resins; vinyl resins, such as polyvinyl chloride; and vinylidene resins, such as polyvinylidene chloride. Modified products or blends of these resins are also useful.

While the cleaning sheet 1 described above has not only the first side 1a but the second side 1b raised as shown in FIG. 1, it may have only one side 1a or 1b raised. In such a case, the raising part 20C of the apparatus 20 only has to have either one of the engraved rollers 31 and 34.

While the cleaning sheet 1 is three-dimensionally textured with protrusions 2 and depressions 3 in a staggered pattern as shown in FIG. 1, the protrusions 2 and the depressions 3 may be arranged in stripes or may individually be patterned for decorative purposes. While the cleaning sheet 1 has fibers raised on the entire area thereof including the protrusions 2 and the depressions 3, the precursor sheet may be raised in parts and then three-dimensionally textured to have part of the protrusions and part of the depressions raised.

While the raising part 20C of the apparatus 20 used to make the cleaning sheet 1 includes engraved rollers 31 and 34 having projections 310 and 340 on their peripheral surface as shown in FIG. 7, the engraved rollers 31 and 34 may be replaced with a pair of corrugated rollers having mating teeth and grooves on their peripheral surface. A knurled roller, a roller having a thermal spray coating, or a carding wire may also be used to achieve raising. A member providing a frictional resistance, such as a rubber or sand roller having rubber or sand paper around its peripheral surface, may also be used. The formation of a laminate 6 (a precursor of the cleaning sheet 1) in the joining part 20A and entanglement part 20B, the raising in the raising part 20C, and the deformation in the texturing part 20D and bonding part 20E may be performed either continuously or discontinuously.

In making the cleaning sheet 1, the hydrophilic fiber aggregate 11 taken off the stock roll 23 as shown in FIG. 7 has the form of nonwoven fabric. Instead of this, a continuous fiber web may be used. In such a case, an additional card is installed between the cards 21A and 21B, and a carded fiber web from the additional card is continuously fed as a hydrophilic fiber aggregate 11.

The following clauses relative to the foregoing embodiments for the cleaning sheet and the method for making the cleaning sheet are disclosed below.

(1) A cleaning sheet comprising a hydrophilic fiber aggregate composed mainly of hydrophilic fibers, and a hydrophobic fiber aggregate composed mainly of hydrophobic fibers and arranged on both sides of the hydrophilic fiber aggregate, the hydrophobic fiber aggregate having its constituent fibers entangled with one another, entering the hydrophilic fiber aggregate, and entangled with fibers constituting the hydrophilic fiber aggregate in a way that the hydrophilic fiber aggregate and the hydrophilic fiber aggregate are united together,

the cleaning sheet being three-dimensionally textured with a plurality of protrusions and a plurality of depressions on both sides thereof in a pattern such that protrusions on one side correspond to depressions on the other side and that depressions on one side correspond to protrusions on the other side, and

the cleaning sheet having a linear bond where the hydrophilic fiber aggregate and the hydrophobic fiber aggregate are bonded to each other.

(2) The cleaning sheet according to clause (1), having raised fibers raised from the surface of the protrusions and the surface of the depressions.
(3) The cleaning sheet according to clause (2), wherein the raised fibers are fibers constituting the hydrophobic fiber aggregate or the raised fibers include a fiber constituting the hydrophobic fiber aggregate and a fiber constituting the hydrophilic fiber aggregate.
(4) The composite sheet according to clause (2) or (3), wherein the number of raised fibers raised in the individual depressions is larger than the number of raised fibers raised in the individual protrusions.
(5) The cleaning sheet according to one of clauses (2) to (4), wherein the fiber raised in the individual depressions has a height of preferably 0.1 mm or more, more preferably 0.5 mm or more, and 30 mm or less, more preferably 20 mm or less.
(6) The cleaning sheet according to one of clauses (2) to (5), wherein the number of the raised fibers raised in the depressions is preferably 5 or greater, more preferably 10 or greater, and 100 or fewer, more preferably 90 or fewer, per 10 mm width.
(7) The cleaning sheet according to one of clauses (2) to (6), wherein the fiber raised in the individual protrusions has a height of preferably 0.1 mm or more, more preferably 0.5 mm or more, and 30 mm or less, more preferably 20 mm or less.
(8) The cleaning sheet according to one of clauses (2) to (7), wherein the number of the raised fibers on the protrusions is preferably 5 or greater, more preferably 10 or greater, and 80 or fewer, more preferably 70 or fewer, per 10 mm width.
(9) The cleaning sheet according to one of clauses (1) to (8), wherein the linear bond intersects an imaginary line connecting the tops of two protrusions adjacent to each other at the shortest distance d.
(10) The cleaning sheet according to clause (9), wherein the linear bond intersects the imaginary line at an angle of 3° to 30°.
(11) The cleaning sheet according to one of clauses (1) to (10), wherein the individual protrusions have a plan view area of 1 mm² or more, more preferably 4 mm² or more, and 100 mm² or less, more preferably 25 mm² or less.
(12) The cleaning sheet according to one of clauses (1) to (11), wherein the individual depressions have a plan view area of 1 mm² or more, more preferably 4 mm² or more, and 100 mm² or less, more preferably 25 mm² or less.
(13) The cleaning sheet according to one of clauses (1) to (12), wherein the linear bond has a bonding width preferably of 0.3 mm or more, more preferably 0.5 mm or more, and 5 mm or less, more preferably 3 mm or less.
(14) The cleaning sheet according to one of clauses (1) to (13), wherein the distances between adjacent protrusions and between adjacent depressions in the longitudinal direction (direction X) is preferably 1 mm or longer, more preferably 4 mm or longer, and preferably 20 mm or shorter.
(15) The cleaning sheet according to one of clauses (1) to (14), wherein the distances between adjacent protrusions and between adjacent depressions in the transverse direction (direction Y) is preferably 1 mm or longer, more preferably 4 mm or longer, and preferably 20 mm or shorter.
(16) The cleaning sheet according to one of clauses (1) to (15), wherein the distances between adjacent linear bonds is preferably 10 mm or more, more preferably 13 mm or more, and 40 mm or less, more preferably 30 mm or less.
(17) The cleaning sheet according to one of clauses (1) to (16), wherein the proportion of the hydrophilic fiber aggregate in the cleaning sheet is preferably 30 mass % or more, more preferably 40 mass % or more, and 75 mass % or less, more preferably 70 mass % or less.
(18) The cleaning sheet according to one of clauses (1) to (17), wherein the hydrophilic fiber aggregate has a larger basis weight than the hydrophobic fiber aggregate per side.
(19) The cleaning sheet according to one of clauses (1) to (18), wherein the linear bond is a continuous line or a discontinuous line composed of a number of closely spaced rectangular, square, rhombic, circular, cross-shaped, or otherwise shaped bonds.
(20) A method for making the cleaning sheet according to clause (2), comprising the steps of superposing the hydrophobic fiber aggregate on each side of the hydrophilic fiber aggregate to make a stack, entangling the fibers of the hydrophilic fiber aggregate and the fibers of the hydrophobic fiber aggregate by applying high-pressure water jets to each side of the stack to unite the stack into a laminate, subjecting the laminate to raising on both sides thereof, texturing a plurality of regions of the raised laminate with protrusions and depressions, and seal bonding the textured laminate to form a linear bond at which the hydrophilic fiber aggregate and the hydrophobic fiber aggregates are bonded together.
(21) The method for making the cleaning sheet according to clause (20), wherein the raising is carried out using a rotating engraved roller having a plurality of projections on its peripheral surface.
(22) The method for making the cleaning sheet according to clause (21), wherein the engraved roller rotates in a direction reverse to the moving direction of the laminate.
(23) The method for making the cleaning sheet according to clause (22), wherein the ratio of the peripheral velocity V3 of the engraved roller to the transport rate V2 of the laminate, V3/V2, is preferably 0.3 or higher, more preferably 1.1 or higher, even more preferably 1.5 or higher, and preferably 20 or lower, more preferably 15 or lower, even more preferably 12 or lower, and preferably V3>V2.
(24) The method for making the cleaning sheet according to one of clauses (20) to (23), wherein the texturing is carried out using a steel-to-steel matched embossing unit including a pair of embossing rollers.
(25) The cleaning sheet according to one of clauses (9) to (19), wherein the plurality of protrusions are arranged at a regular spacing in a direction such that the imaginary line extends in a first direction and arranged at a distance substantially equal to the distance in a second direction perpendicular to the first direction, and

the cleaning sheet is textured three-dimensionally in such a pattern that the depression is surrounded by four protrusions.

(26) The cleaning sheet according to clause (25), wherein the linear bond intersects the first direction and the second direction.
(27) The cleaning sheet according to clause (25) or (26), wherein the linear bond includes a number of regularly spaced parallel first linear bonds and a number of regularly spaced parallel second linear bonds.
(28) The cleaning sheet according to clause (27), wherein the first linear bonds and the second linear bonds intersect the first direction and the second direction.
(29) The cleaning sheet according to clause (27) or (28), wherein the first linear bonds and the second linear bonds intersect at an angle of 20° to 160°.

### EXAMPLES

The invention will now be illustrated in greater detail with reference to Examples, but it should be understood that the invention is not limited thereto.

### Example 1

A cleaning sheet of FIG. 1 was made by the method shown in FIG. 7. A fiber web having a basis weight of 30 g/m² was prepared by carding polyester fiber (1.45 dtex; fiber length: 38 mm; 100%) in a usual manner. Hydroentangled nonwoven fabric having a basis weight of 40 g/m² and containing 100 mass % hydrophilic rayon fiber was used as a hydrophilic fiber aggregate (backbone material). The fiber web was superposed on the upper and lower side of the hydroentangled nonwoven fabric. The resulting stack was united by entanglement with water jets jetted from a plurality of nozzles, followed by drying to obtain a laminate having hydrophobic fiber aggregates. The laminate was raised on both sides thereof using the engraved rollers 31 and 34. The engraved rollers 31 and 34 rotated in a direction reverse to the moving direction of the laminate. The wrap angle β of the laminate around each engraved roller was 130°. The projections 310 and 340 of the engraved rollers 31 and 34 had a height of about 0.07 mm. The distance between adjacent projections (the pitch of the projections) in the circumferential direction and that in the axial direction were each about 0.22 mm. The number of the projections per unit area was 2000/cm². The laminate was then passed through the steel-to-steel matched embossing unit 43 to be textured with protrusions and depressions. The surface temperature of the rollers 41 and 42 was 105° C. The protrusions 411 of the roller 41 had a height of 2.0 mm, and the depth of engagement between the protrusions 411 of the roller 41 and the recesses 422 of the roller 42 was 1.6 mm. The distance (pitch) between the protrusions 411 adjacent in the axial direction was 7 mm, and that in the circumferential direction was 7 mm. The textured laminate was introduced between the ultrasonic horn 51 and the patterning roller 52 to form linear bonds at which the hydroentangled nonwoven fabric and the fiber web on both sides of the nonwoven fabric were bonded and united together. The angle α of intersection between the first linear bonds 15a and the second linear bonds 15b was 67° (each linear bond made an angle of 67/2° with the MD (direction X)). The width W1 of the first and second linear bonds was 1 mm. The distance W2 between adjacent first linear bonds 15a and between adjacent second linear bonds 15b was 22 mm. The cleaning sheet of Example 1 was produced under these conditions. In the resulting cleaning sheet, the intersecting angle γ between a first imaginary line ILa connecting the tops of adjacent protrusions 2 and the first linear bond 15a was 10°, and the intersecting angle δ between a 12th imaginary line ILb connecting the tops of adjacent protrusions and the second linear bond 15b was 10°.

### Example 2

A cleaning sheet of Example 2 was made in the same manner as in Example 1, except that the raising using the engraved rollers 31 and 34 was not conducted.

### Example 3

A cleaning sheet of Example 3 was made in the same manner as in Example 1, except that the stack to be entangled with water jets was prepared by superposing a mesh sheet on the lower side of the hydroentangled nonwoven fabric, superposing the fiber web on the upper side of the hydroentangled nonwoven fabric, and superposing the fiber web on the lower side of the hydroentangled nonwoven fabric via the mesh sheet.

### Example 4

A cleaning sheet of Example 4 was made in the same manner as in Example 1, except for using, as a backbone material, hydroentangled nonwoven fabric having a basis weight of 50 g/m² and containing 80 mass % hydrophilic rayon fiber and 20 mass % sheath/core conjugate fiber made of polyethylene and polypropylene.

### Comparative Example 1

Similarly to Example 1, a fiber web having a basis weight of 30 g/m² was prepared by carding polyester fiber (1.45 dtex; fiber length: 38 mm; 100%) in a usual manner. Similarly to Example 1, hydroentangled nonwoven fabric having a basis weight of 40 g/m² and containing 100 mass % hydrophilic rayon fiber was used as a hydrophilic fiber aggregate. The fiber web was superposed on the upper and lower side of the hydroentangled nonwoven fabric. The resulting stack was united by entanglement with water jets jetted from a plurality of nozzles, followed by drying to obtain a laminate having hydrophobic fiber aggregates. The resulting laminate was used as a cleaning sheet of Comparative Example 1. Unlike the cleaning sheets of Examples, the cleaning sheet of Comparative Example 1 had no linear bonds for bonding and uniting the laminate.

### Comparative Example 2

A commercially available cleaning sheet, Quickle Wiper Three-dimensional Absorbent Dry sheet, from Kao Corp. was used as a cleaning sheet of Comparative Example 2.

### Comparative Example 3

In the same manner as in Example 1, a fiber web having a basis weight of 30 g/m² was prepared by carding polyester fiber (1.45 dtex; fiber length: 38 mm; 100%) in a usual manner. Without using a hydrophilic fiber aggregate, the resulting fiber web alone was subjected to entanglement by water jets from a plurality of nozzles and dried to give a hydrophobic fiber aggregate, which was used as a cleaning sheet of Comparative Example 3.

### Comparative Example 4

The same hydroentangled nonwoven fabric as used as a hydrophilic fiber aggregate in making the cleaning sheet 1 of Example (basis weight: 40 g/m²; 100 mass % hydrophilic rayon fiber) was used as a cleaning sheet of Comparative Example 4.

### Performance Evaluation:

The cleaning sheets of Examples 1 to 4 and Comparative Examples 1 to 4 were evaluated for sprinkled water absorptivity, hair trapping performance, fine dust trapping performance, fluffy dust retaining properties, elongation, and resistance to mopping motion in accordance with the methods below. All the evaluations were made in an environment of room temperature (20° C.) and 60% RH. The results obtained are shown in Table 1.

### (a) Sprinkled Water Absorptivity

Each of the cleaning sheets of Examples 1 to 4 and Comparative Examples 1 to 5 was attached to the head of a cleaning implement, Quickie Wiper® from Kao Corp. On a 30 cm by 90 cm piece of wood flooring (Woody F from Matsushita Electric Works Co., Ltd.) was dropped 0.3 ml of ion exchanged water and wiped up by the cleaning sheet attached to the head in a single, one-way mopping motion of over a given distance (60 cm) of the flooring. The mass of the ion exchanged water absorbed by the cleaning sheet was obtained by subtracting the mass of the cleaning sheet before mopping from the total mass of the cleaning sheet after mopping. The above test was repeated sequentially using five cleaning sheets of a kind to determine the total mass of absorbed ion-exchanged water out of 1.5 ml (total mass of sprinkled ion-exchanged water). The total mass of absorbed water was divided by 1.5, and the quotient was multiplied by 100 to give a water absorbency (%).

Absorptivity for sprinkled water was rated as follows.

A: Good absorptivity with an absorbency of 70% or more.
B: Practically sufficient absorptivity with an absorbency of 50% or more and less than 70%.
C: A slightly low and yet practical level of absorptivity with an absorbency of 40% or more and less than 50%.
D: A practically unacceptable level of absorptivity with an absorbency less than 40%.

### (b) Hair Trapping Performance

(b-1) Hair Trapping Performance on Dry Floor

Each of the cleaning sheets of Examples 1 to 4 and Comparative Examples 1 to 4 was attached to the head of a cleaning implement, Quickie Wiper® from Kao Corp. On a 30 cm by 90 cm piece of wood flooring (Woody F from Matsushita Electric Works Co., Ltd.) were scattered ten human hairs of about 10 cm in length. The hairs were collected by the cleaning sheet attached to the head in a single, one-way mopping motion over a given distance (60 cm) on the flooring, and the number of the hairs captured by the cleaning sheet was counted. The above test was repeated sequentially using five cleaning sheets of a kind to obtain the total number of hairs captured out of 50. The total number of the captured hairs was divided by 50, and the quotient was multiplied by 100 to give a hair trapping ratio (%).

### (b) Hair Trapping Performance

(b-2) Hair Trapping Performance on Wet Floor

Each of the cleaning sheets of Examples 1 to 4 and Comparative Examples 1 to 4 was attached to the head of a cleaning implement, Quickie Wiper® from Kao Corp. On a 30 cm by 90 cm piece of wood flooring (Woody F from Matsushita Electric Works Co., Ltd.) was dropped 0.3 ml of ion exchanged water and spread to an area equal to the size of the head of the cleaning implement (about 10 cm by 25 cm). Ten human hairs of about 10 cm in length were scattered on the wetted area of the flooring and lightly pressed to the flooring by a finger. The hairs were collected by five, two-way (forward-and-backward) mopping motions of the cleaning sheet attached to the head over a given distance (60 cm) on the flooring, and the number of the hairs captured by the cleaning sheet was counted. The above test was repeated sequentially using five cleaning sheets of a kind to obtain the total number of hairs captured out of 50. The total number of the captured hairs was divided by 50, and the quotient was multiplied by 100 to give a hair trapping ratio (%).

The hair trapping performance of the cleaning sheet on the dry or wet floor was rated as follows.

A: A hair trapping ratio of 80% or more. Good hair trapping performance.
B: A hair trapping ratio of 60% or more and less than 80%. Practically sufficient hair trapping performance.
C: A hair trapping ratio of 40% or more and less than 60%. A slightly poor and yet practical level of hair trapping performance.
D: A hair trapping ratio of less than 40%. An impractical level of hair trapping performance.

### (c) Fine Dust Trapping Performance

Each of the cleaning sheets of Examples 1 to 4 and Comparative Examples 1 to 4 was attached to the head of a cleaning implement, Quickle Wiper® from Kao Corp. A 0.2 g of JIS test powder 1, class 7 specified in JIS Z8901 “Test powders and test particles” and available from The Association of Powder Process Industry and Engineering, JAPAN was scattered on substantially the entire area of a 90 cm by 90 cm piece of wood flooring (Woody F from Matsushita Electric Works Co., Ltd.). The entire area of the flooring was cleaned by giving two, two-way (forward-and-backward) mopping motions of the cleaning sheet attached to the head over a given distance (90 cm), and the mass of the dust collected by the cleaning sheet was weighed. The mass of the dust collected by the cleaning sheet was obtained by subtracting the mass of the cleaning sheet before mopping from the total mass of the cleaning sheet after mopping. The above test was repeated sequentially using five cleaning sheets of a kind to record the total mass of collected dust. The total mass of the collected dust was divided by 1.0 (total mass of the scattered dust), and the quotient was multiplied by 100 to give a dust trapping ratio (%).

The dust trapping performance of the cleaning sheet was rated as follows.

A: A dust trapping ratio of 70% or more. Good fine-dust trapping performance.
B: A dust trapping ratio of 50% or more and less than 70%. A practically sufficient level of fine-dust trapping performance.
C: A dust trapping ratio of 40% or more and less than 50%. A slightly poor and yet practically acceptable level of fine-dust trapping performance.
D: A dust trapping ratio of less than 40%. An impractical level of fine-dust trapping performance.

### (d) Model Fluffy Dust Retaining Performance

Each of the cleaning sheets of Examples 1 to 4 and Comparative Examples 1 to 4 was attached to the head of a cleaning implement, Quickle Wiper® from Kao Corp. As model fluffy dust, 0.05 g of cut and well-loosened absorbent cotton (100% cotton, available from Yamato Kojyo) was scattered on an area equal to the size of the cleaning head of the cleaning implement (about 10 cm by 25 cm) of a 30 cm by 90 cm piece of wood flooring (Woody F from Matsushita Electric Works Co., Ltd.). The cleaning head was moved on the flooring in a two-way (forward-and-backward) mopping motion 60 times over a given distance (60 cm) to make the model fluffy dust entangled with the sheet. On the flooring was then dropped 0.3 ml of ion exchanged water and wiped up with the same sheet as attached to the cleaning head by five forward-and-backward mopping motions over a given distance (60 cm). After the model fluffy dust fallen on the flooring was collected, dropping of ion exchanged water and wiping operations were repeated a total of five times using the same sheet. The model fluffy dust fallen and collected from the flooring was dried in an electric dryer and left to stand in an environment of room temperature (20° C.) and 60% RH until stabilization of the mass, and weighed. The mass of the model fluffy dust retained in the cleaning sheet was calculated by subtracting the total mass of the model fluffy dust fallen on the flooring from the total mass of the scattered model fluffy dust. The above test was repeated sequentially using three cleaning sheets of a kind to record the total mass of the fluffy dust retained in the three cleaning sheets (total retention mass). The total retention mass was divided by 0.15 (total mass of the scattered fluffy dust), and the quotient was multiplied by 100 to give a model fluffy dust retention (%).

The fluffy dust retaining performance of the cleaning sheet was rated based on the retention as follows.

A: A retention of 80% or more. Good retaining performance for model fluffy dust.
B: A retention of 60% or more and less than 80%. A practically sufficient level of retaining performance for model fluffy dust.
C: A retention of 40% or more and less than 60%. A slightly poor and yet practically acceptable level of retaining performance for model fluffy dust.
D: A retention of less than 40%. An impractical level of retaining performance for model fluffy dust.

### (e) Sheet Elongation

Each of the cleaning sheets of Examples 1 to 4 and Comparative Examples 1 to 4 was attached to the head of a cleaning implement, Quickle Wiper® from Kao Corp. The cleaning sheet was previously marked with two straight lines corresponding to the two longer sides of the head to which it was attached. These benchmarks extended in the longitudinal direction of the sheet at a 10 cm spacing therebetween. On a 30 cm by 90 cm piece of wood flooring (Woody F from Matsushita Electric Works Co., Ltd.) was dropped 1 ml of ion exchanged water and wiped up with the cleaning sheet attached to the head by giving 20 forward-and-backward mopping motions over a given distance (60 cm). The cleaning sheet was removed from the head, and the distance between the straight lines extending in the longitudinal direction of the cleaning sheet was measured. The measured distance was divided by 10 (the initial distance between the straight lines), and the quotient was multiplied by 100 to give a sheet elongation (%). The sheet elongation was rated as follows.

A: A sheet elongation of less than 10%. No elongation during use for cleaning a surface to be cleaned or attachment to a cleaning implement. Convenient to use.
B: A sheet elongation of 10% or more and less than 20%. Little elongation during use for cleaning a surface to be cleaned or attachment to a cleaning implement. No problem for practical use.
C: A sheet elongation of 20% or more and less than 40%. The cleaning sheet sometimes elongates during use for cleaning a surface to be cleaned or attachment to a cleaning implement and therefore has slightly poor and yet practically acceptable convenience to use.
D: A sheet elongation of 40% or more. The cleaning sheet is unsuited for use due to elongation during use for cleaning a surface to be cleaned or attachment to a cleaning implement.

### (f) Resistance to Mopping Motion

(f-1) Resistance to Mopping Motion on Dry Floor

Each of the cleaning sheets of Examples 1 to 4 and Comparative Examples 1 to 4 was cut to prepare five circular specimens of 25 mm in diameter. A coefficient μ of static friction of each specimen on its raised surface was determined using Heidon Tribogear Muse Type:94i available from Shinto Scientific Co., Ltd. An average of values of five specimens was taken as a measure for resistance to mopping motion.

(f-2) Resistance to Mopping Motion on Wet Floor

Each of the cleaning sheets of Examples 1 to 4 and Comparative Examples 1 to 4 was cut to prepare five circular specimens of 25 mm in diameter. Under the raised surface of each specimen was dripped 0.1 ml of ion exchanged water. After the specimen was allowed to stand for 10 seconds, a coefficient μ of static friction of the specimens on its raised surface was determined using Heidon Tribogear Muse Type:94i available from Shinto Scientific Co., Ltd. An average of μ values of five specimens was taken as a measure for resistance to mopping motion. The resistance to mopping motion of the cleaning sheet was rated based on the average μ value as follows.

A: An average μ value of smaller than 0.40. Convenient to use with little resistance to mopping operation.
B: An average μ value of 0.40 or greater and smaller than 0.60. Slightly less convenient to use due to high resistance to mopping operation but still practical to use.
C: An average μ value of 0.60 or greater. Poor in convenience of use and impractical for use due to large resistance to mopping operation.

TABLE 1-1

| | | Example 1 | Example 2 | Example 3 | Example 4 |
|---|---|---|---|---|---|
| Hydrophobic Fiber | Basis Weight. | 30 | 30 | 30 | 30 |
| Aggregate | (g/m²) | | | | |
| | Kind | polyester | polyester | polyester | polyester |
| | | fiber | fiber | fiber | fiber |
| Hydrophobic Fiber | Basis Weight. | 40 | 40 | 40 | 50 |
| Aggregate | (g/m²) | | | | |
| | Kind | rayon-based | rayon-based | rayon-based | rayon-based |
| | | hydroentangled | hydroentangled | hydroentangled | hydroentangled |
| | | nonwoven fabric | nonwoven fabric | nonwoven fabric | nonwoven fabric |
| Mesh Sheet | Basis Weight. | — | — | 5 | — |
| | (g/m²) | | | | |
| | Kind | — | — | polypropyl- | — |
| | | | | ene net | |
| Processing Steps | | entangle- | entangle- | entangle- | entangle- |
| | | ment→raising→SM*→ | ment→SM→ | ment→raising→SM→ | ment→raising→SM→ |
| | | linear embossing | linear embossing | linear embossing | linear embossing |
| Sprinkled Water Absorptivity | | A | A | A | A |
| Hair Trapping Performance on Dry Floor | | A | A | A | A |
| Hair Trapping Performance on Wet Floor | | A | C | A | A |
| Model Fluffy Dust Retaining Performance | | A | B | A | A |
| on Wet Floor | | | | | |
| Sheet Elongation | | A | A | A | A |
| Resistance to Mopping on Dry Floor | | A | A | A | A |
| Resistance to Mopping on Wet Floor | | A | A | A | A |
| Height of Raised Fiber | Ave. (h2) (mm) | 1.47 | 0.25 | 1.82 | 1.63 |
| (h2) in Protrusions | Max. (mm) | 9.47 | 1.05 | 10.37 | 10.45 |
| | Min. (mm) | 0.12 | 0.10 | 0.12 | 0.12 |
| Height of Raised Fiber | Ave. (h3) (mm) | 1.38 | 0.37 | 1.75 | 1.73 |
| (h3) in Depressions | Max. (mm) | 8.57 | 1.11 | 10.58 | 10.89 |
| | Min. (mm) | 0.11 | 0.10 | 0.11 | 0.12 |
| Number of Raised | (/10mm) | 46 | 18 | 40 | 46 |
| Fibers on Protrusions | | | | | |
| Number of Raised | (/10mm) | 75 | 26 | 64 | 73 |
| Fibers in Depressions | | | | | |

| | | Compara. | Compara. | Compara. | Compara. |
|---|---|---|---|---|---|
| | | Example 1 | Example 2 | Example 3 | Example 4 |
| Hydrophobic Fiber | Basis Weight. | 30 | 48 | 30 | — |
| Aggregate | (g/m² ) | | | | |
| | Kind | polyester | polyester | polyester | — |
| | | fiber | fiber | fiber | |
| Hydrophobic Fiber | Basis Weight. | 40 | — | — | 40 |
| Aggregate | (g/m²) | | | | |
| | Kind | rayon-based | — | — | rayon-based |
| | | hydroentangled | | | hydroentangled |
| | | nonwoven fabric | | | nonwoven fabric |
| Mesh Sheet | Basis Weight. | — | 5 | — | — |
| | (g/m²) | | | | |
| | Kind | — | polypropyl- | — | — |
| | | | ene net | | |
| Processing Steps | | entan- | commercial | entan- | — |
| | | glement | product | glement | |
| Sprinkled Water Absorptivity | | A | D | D | A |
| Hair Trapping Performance (on dry floor) | | A | B | A | C |
| Hair Trapping Performance (on wet floor) | | C | D | C | D |
| Model Fluffy Dust Retaining Performance | | C | D | D | C |
| (on wet floor) | | | | | |
| Sheet Elongation | | A | A | A | D |
| Resistance to Mopping on Dry Floor | | A | A | A | A |
| Resistance to Mopping on Wet Floor | | B | A | A | C |
| Height of Raised Fiber | Ave. (h2) (mm) | — | — | — | — |
| (h2) in Protrusions | Max. (mm) | — | — | — | — |
| | Min. (mm) | — | — | — | — |
| Height of Raised Fiber | Ave. (h3) (mm) | — | — | — | — |
| (h3) in Depressions | Max. (mm) | — | — | — | — |
| | Min. (mm) | — | — | — | — |
| Number of Raised | (/10 mm) | — | — | — | — |
| Fibers on Protrusions | | | | | |
| Number of Raised | (/10 mm) | — | — | — | — |
| Fibers in Depressions | | | | | |

*SM: steel-to-steel matched embossing

As is apparent from the results in Table 1, the cleaning sheets of Examples 1 to 4, particularly of Examples 1, 3, and 4 are superior to those of Comparative Examples 1 to 4 in hair trapping performance on wet floor and model fluffy dust retaining performance.

As is apparent from the results in Table 1, the cleaning sheets of Examples 1 to 4 exhibit high hair trapping performance on dry floor.

As is apparent from the results in Table 1, the cleaning sheets of Examples 1 to 4 are superior to those of Comparative Examples 2 and 3 in sprinkled water absorbing performance. Cleaning sheets with such high water absorbing performance allow little absorbed water to go back to the floor.

As is apparent from the results in Table 1, the cleaning sheets of Examples 1 to 4 show no resistance to mopping operation on dry or wet floor and are appreciated for their good convenience when used as attached to the head of a cleaning implement.

### INDUSTRIAL APPLICABILITY

The cleaning sheet of the invention hardly elongates during a cleaning operation and is thereby prevented from causing inconveniences, such as coming off a sweeper. The cleaning sheet of the invention is capable of smoothly transferring water wiped up from a floor to the inner hydrophilic fiber aggregate and allows little absorbed water to go back onto the floor. The cleaning sheet of the invention exhibits improved dirt trapping and retaining performance and improved convenience to use in a mopping operation as attached to the head of a cleaning implement.

1. A cleaning sheet comprising a hydrophilic fiber aggregate composed mainly of hydrophilic fibers, and a hydrophobic fiber aggregate composed mainly of hydrophobic fibers and arranged on both sides of the hydrophilic fiber aggregate, the hydrophobic fiber aggregate having its constituent fibers entangled with one another, entering the hydrophilic fiber aggregate, and entangled with fibers constituting the hydrophilic fiber aggregate in a way that the hydrophilic fiber aggregate and the hydrophilic fiber aggregate are united together,
the cleaning sheet being three-dimensionally textured with a plurality of protrusions and a plurality of depressions on both sides thereof in a pattern such that protrusions on one side correspond to depressions on the other side and that depressions on one side correspond to protrusions on the other side,
the cleaning sheet having raised fibers raised from the surface of the protrusions and the surface of the depressions,
the raised fiber raised in the individual depressions having a height of 0.1 to 30 mm, and the number of the raised fibers raised in the depressions being 5 to 100 per 10 mm width, and
the cleaning sheet having a linear bond where the hydrophilic fiber aggregate and the hydrophobic fiber aggregate are bonded to each other.

2. The cleaning sheet according to claim 1, wherein the linear bond intersects an imaginary line connecting the tops of two protrusions adjacent to each other at the shortest distance.

3. The cleaning sheet according to claim 1, wherein the individual protrusions have a plan view area of 1 to 100 mm², and the linear bond has a bonding width of 0.3 to 5 mm.

4. The cleaning sheet according to claim 1, wherein the hydrophilic fiber aggregate has a larger basis weight than the hydrophobic fiber aggregate per side.

5. The cleaning sheet according to claim 1, wherein the fiber raised in the individual protrusions has a height of 0.5 mm or more and 30 mm or less.

6. The cleaning sheet according to claim 1, wherein the number of the raised fibers on the protrusions is 5 or greater per 10 mm width and 80 or fewer per 10 mm width.

7. The cleaning sheet according to claim 2, wherein the linear bond intersects the imaginary line at an angle of 3° to 30°.

8. A method for making the cleaning sheet according to claim 1, comprising the steps of superposing the hydrophobic fiber aggregate on each side of the hydrophilic fiber aggregate to make a stack, entangling the fibers of the hydrophilic fiber aggregate and the fibers of the hydrophobic fiber aggregate by applying high-pressure water jets to each side of the stack to unite the stack into a laminate, subjecting the laminate to raising on both sides thereof, texturing a plurality of regions of the raised laminate with protrusions and depressions, and seal bonding the textured laminate to form a linear bond at which the hydrophilic fiber aggregate and the hydrophobic fiber aggregates are bonded together.

9. The method for making the cleaning sheet according to claim 8, wherein the raising is carried out using a rotating engraved roller having a plurality of projections on its peripheral surface.

10. The method for making the cleaning sheet according to claim 9, wherein the engraved roller rotates in a direction reverse to the moving direction of the laminate.

11. The method for making the cleaning sheet according to claim 9, wherein the peripheral velocity V3 of the engraved roller and the transport rate V2 of the laminate satisfy a relationship of V3>V2.
